(19) United States
(12) Patent Application Publication
(10) Pub. No.: US 2011/0022563 A1
(43) Pub. Date: Jan. 27, 2011

(54) DOCUMENT DISPLAY SYSTEM, RELATED DOCUMENT DISPLAY METHOD, AND PROGRAM

(75) Inventors: Keisuke MATSUBARA, Yokohama (JP); Katsushi Yako, Yokohama (JP); Katsuro Kikuchi, Musashino (JP); Naoki Inoue, Kawasaki (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/708,305

(22) Filed: Feb. 18, 2010

(30) Foreign Application Priority Data
Jul. 23, 2009 (JP) 2009-172387

(51) Int. Cl. G06N 5/02

(52) U.S. Cl. 706/50

(57) ABSTRACT

It is an object of the present invention to appropriately display a related document at the time when a user browses a document in a survey business using a set of documents as electronic data. A related document display system of the present invention includes a related learning controller that stores both related documents as an available related link based on a past document preparation in a set of documents in a related link storage unit (related link management information), and a recommended controller (proxy unit) that then refers, when the user browses any one of documents in the set of documents, to the related link storage unit, extracts a document having an available related link along with the browsed document, and displays the extracted document on a display unit as a document related to the browsed document.

### INCORPORATION BY REFERENCE

The present application claims priority from Japanese Patent Application JP2009-172387 filed on Jul. 23, 2009, the content of which is hereby incorporated by reference into this application.

### BACKGROUND OF THE INVENTION

The present invention relates to a recommendation function for recommending (displaying) a related document at the time when a user browses a document from a set of documents as electronic data.

There is present a business that a further survey is performed from vague existing information to obtain desired information. For example, the business is a survey business that a user (surveyor) surveys a document to inquiry contents from a customer using an in-house system or Internet and a technical support center or help desk gives survey results to the customer.

In the survey business, a user follows a search or link in an in-house system or Internet through a trial and error process to refer to a number of reference documents. In the above-described method, an information search is generally performed only from the viewpoint of an information provider (Web page provider), and therefore, an operation efficiency is low.

On the other hand, a technique for recommending information from the viewpoint of a user is as follows. Disclosed is, for example, one technique that when a search keyword is input to a search keyword input column in a browser, a statistically-learned related search keyword is presented (refer to Patent Document 1). In addition, disclosed is another technique that when a user refers to a book at an Internet book sales site, he or she that buys the referred-to book based on a past purchase history of users presents a separately-purchased book (refer to Patent Document 2; the “book” corresponds to a “document” of the present invention).

Here, Patent Document 1 is US 2005/0198068, and Patent Document 2 is U.S. Pat. No. 6,266,649.

### SUMMARY OF THE INVENTION

In the above-described conventional technique, there is the following problem.

First, in the technique of Patent Document 1, it is an object to select appropriate information from vast amounts of information in the Internet. That is, since the amount of information to be handled is vast, in general, a set of search results also increases in the search only by a few search keywords, and therefore, it becomes difficult to select appropriate information from a list.

To solve the above-described problem, in the technique of Patent Document 1, a vast search log including a number of the same keywords is targeted to perform a statistical processing by paying attention to cooccurrence of keywords, and search keyword candidates as AND conditions are extracted to smaller limit the search results. For example, when the search is performed based on a keyword “recession”, the search keyword such as “cause” or “saving” is recommended as a candidate of a simultaneous search.

On the other hand, in a business (hereinafter, simply referred to a “business”) using a LAN (Local Area Network) system within a company, the amount of information and search traffic density to be targeted are small as compared with the Internet. Therefore, unlike a limited search using the search keyword as AND conditions, it is more important that necessary information is not necessarily present in a set of present search results, but information closely related to a business is efficiently presented. It is important that as regards the search, the search keyword input column is cleared once and then a keyword candidate to be input is presented. However, in the technique of Patent Document 1, a related keyword cannot be presented such that a set of the search results is OR. When the keywords are limited for finding AND, recommendations cannot be appropriately offered in a business in which a large amount of search log is hard to be obtained.

In the technique of Patent Document 2, a plurality of users statistically learn relevance from past referred-to information, a preference of users is extracted as a pattern, and information in which a person having a similar preference is considered to be interested is presented. In short, a preference of persons is patterned while not identifying a person. That is, in the technique of Patent Document 2, a large number of purchase histories are statistically processed by paying attention to cooccurrence of commodities to thereby extract a preference pattern of persons.

On the other hand, a business (e.g., support center) is characterized by the fact that information for reference is greatly different not due to a person in charge of the business, but due to a business item such as a received inquiry. It is considered that information with high relevance for reference at the same time is present in the business, and meanwhile, a use frequency of the same information is not higher than a purchase frequency of the same commodity in Business to Consumer. In the technique of Patent Document 2, information that is closely related to the present business and that has a possibility different from other businesses cannot be recommended for each business. Further, in the technique of Patent Document 2, relevance between both information units in which the number of times of reference is small to a degree unfit for a statistical processing cannot be presented.

In view of the foregoing, it is an object of the present invention to appropriately display a related document at the time when a user browses a document in a survey business using a set of documents as electronic data.

To accomplish the above-described objects, a related document display system of the present invention includes a related learning controller that stores in a related link storage unit both related documents as an available related link based on a past document preparation in a set of documents, and a recommended controller that then refers, when a user browses any one of documents in the set of documents, to the related link storage unit, extracts a document having an available related link to the browsed document, and displays on a display unit the extracted document as a document related to the browsed document. The other units will be described below.

Embodiments of the present invention appropriately display a related document at the time when a user browses a document in a survey business using a set of documents as electronic data.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates one example of a hardware structure of a related document display system according to a first embodiment;

FIG. 2 illustrates one example of a structure of software and hardware of the related document display system according to the first embodiment;

FIGS. 3A and 3B illustrate one example of a principle of the related document display system according to the first embodiment;

FIG. 4 illustrates one example of a related event table according to the first embodiment;

FIG. 5 illustrates one example of an item session-classified available document list table according to the first embodiment;

FIG. 6 illustrates one example of related link management information according to the first embodiment;

FIG. 7 illustrates one example of a keyword table according to the first embodiment;

FIG. 8 illustrates one example of an item session ID Cookie according to the first embodiment;

FIG. 9 illustrates one example of a document Cookie according to the first embodiment;

FIG. 10 illustrates one example of a prepared document table according to the first embodiment;

FIG. 11 illustrates one example of an available document circulating stack according to the first embodiment;

FIG. 12 is a flowchart illustrating one example of the entire flow of a process executed by the related document display system according to the first embodiment;

FIG. 13 illustrates one example of a relationship between respective structures according to the first embodiment;

FIG. 14A is a flowchart illustrating one example of an item session start processing executed by a client according to the first embodiment;

FIG. 14B is a flowchart illustrating one example of an item session ID acquisition processing executed by a content systematized server according to the first embodiment;

FIG. 15 is a flowchart illustrating one example of a processing of a proxy unit executed by the content systematized server according to the first embodiment;

FIG. 16A is a flowchart illustrating one example of a document preparation processing executed by the client according to the first embodiment;

FIG. 16B is a flowchart illustrating one example of a text inserting processing executed by the client according to the first embodiment;

FIG. 16C is a flowchart illustrating one example of a paste processing executed by the client according to the first embodiment;

FIG. 160 is a flowchart illustrating one example of a copy-paste capture processing executed by the content systematized server according to the first embodiment;

FIG. 17 is a flowchart illustrating one example of the entire flow of a generation processing of a related link executed by the content systematized server according to the first embodiment;

FIG. 18 is a flowchart illustrating one example of a preparation processing of an item session-classified available document list according to the first embodiment;

FIG. 19 is a flowchart illustrating one example of a related link generation processing according to the first embodiment;

FIG. 20A is a flowchart illustrating one example of a processing in the browser during a search executed by the client according to the first embodiment;

FIG. 20B is a flowchart illustrating one example of a recommendation processing of a search keyword executed by the content systematized server according to the first embodiment;

FIG. 21A illustrates a concrete example at the time of learning a related link according to the first embodiment;

FIG. 21B illustrates a concrete example at the time of performing a recommendation according to the first embodiment;

FIG. 22 illustrates one example of a structure of software and hardware of a related document display system according to a second embodiment;

FIG. 23 illustrates one example of a related link node according to the second embodiment;

FIG. 24 illustrates one example of a document node according to the second embodiment;

FIG. 25 illustrates one example of a URI-document node correspondence management table according to the second embodiment;

FIG. 26 illustrates one example of a conceptual diagram of a graph structure according to the second embodiment;

FIG. 27 illustrates one example of an item session-classified available document list table and search previously-visited document management table according to the second embodiment;

FIG. 28 illustrates one example of a related link generating stack according to the second embodiment;

FIG. 29 illustrates one example of the entire flow of a process executed by the related document display system according to the second embodiment;

FIG. 30 illustrates one example of a relationship between respective structures according to the second embodiment;

FIG. 31A illustrates one example of a generation process flow of the related link according to the second embodiment;

FIG. 31B illustrates one example of a first search processing according to the second embodiment;

FIG. 31C illustrates one example of a second search processing according to the second embodiment;

FIG. 31D illustrates one example of a calculation processing of a relevance ratio according to the second embodiment; and

FIG. 32 is a flowchart illustrating one example of a recommendation processing of the search keyword executed by a content systematized server according to the second embodiment.

### DESCRIPTION OF THE EMBODIMENTS

Hereinafter, the best mode for carrying out the invention (hereinafter, referred to as an “embodiment”) will be described in the order corresponding to an outline of the present embodiment (first and second embodiments), a first embodiment, and a second embodiment with reference to the accompanying drawings (arbitrarily refer also to drawings except reference drawings).

### <Outline of the Embodiment>

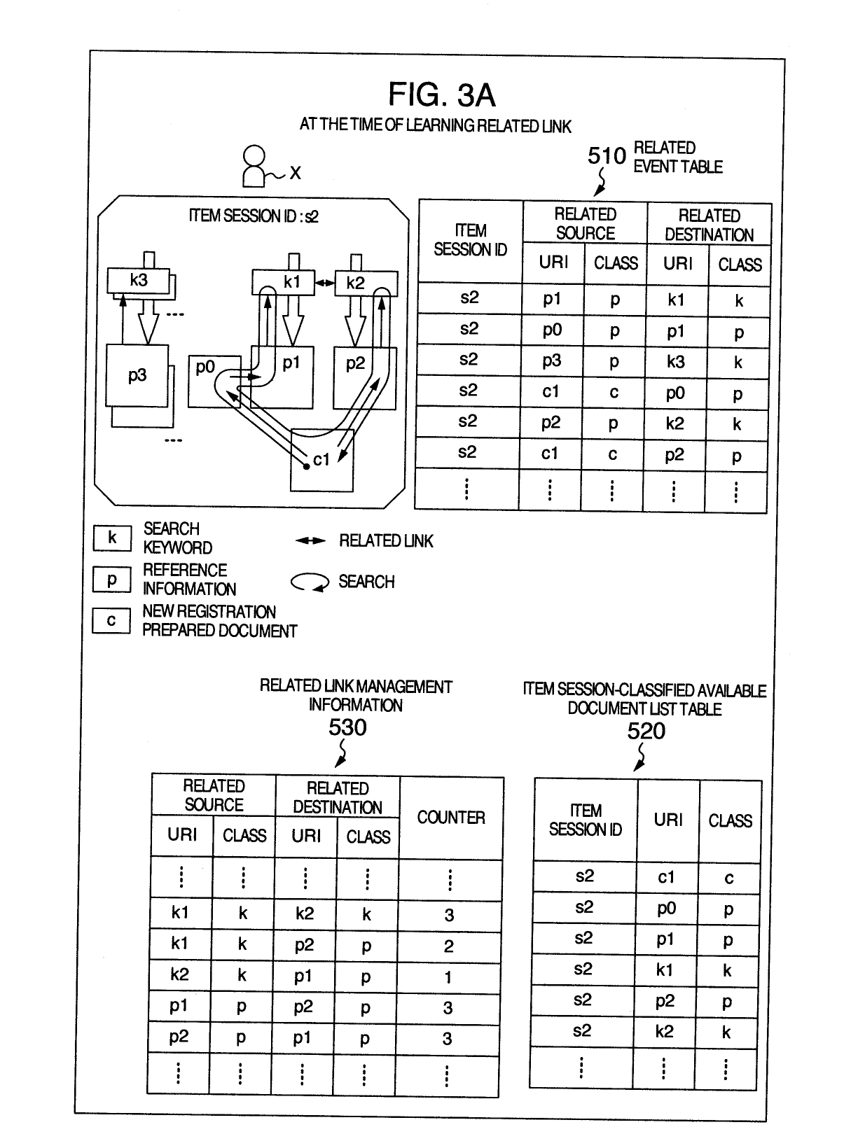

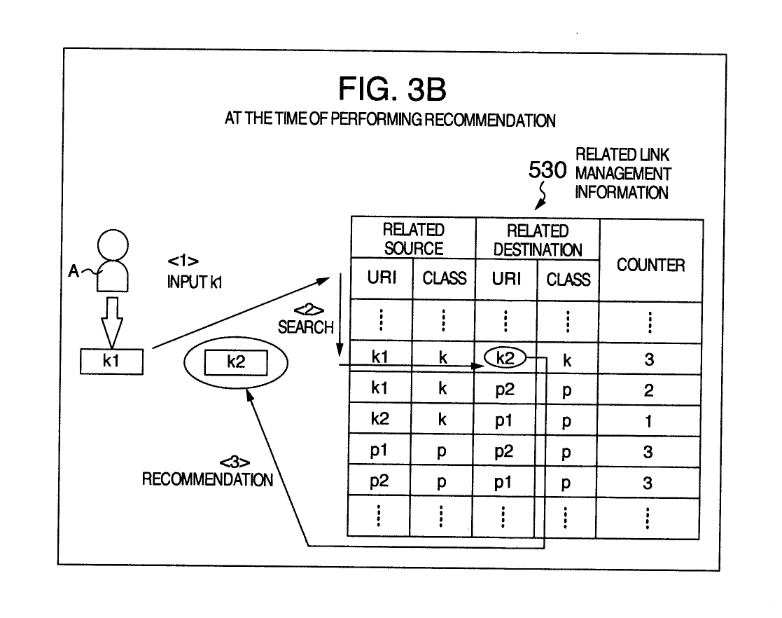

First, an outline of the present embodiment will be described using an example illustrated in FIGS. 3A and 3B. The present embodiment can be roughly classified into (a) one processing at the time of learning a related link in FIG. 3A and (b) another processing at the time of performing a recommendation in FIG. 3B. In the present embodiment, a search keyword is also considered to be a type of document. In other words, the “search keyword” is also contained in a “document” in a scope of claims, and a “search keyword input (by a user)” is also contained in a “browsed document” in the scope of claims. Further, in an outline described below, a case in which a related search keyword at the time when a user inputs a search keyword is particularly presented among relationships of a document-a document, a search keyword-a document, and a search keyword-a search keyword will be described as a concrete example.

### <<Processing at the Time of Learning Related Link>>

First, (a) one processing at the time of learning a related link will be described. As illustrated in FIG. 3A, here, suppose a condition that a user performs a search of documents based on various search keywords (k1 to k3), refers to documents (p0 to p3), and prepares a document (c1, a predetermined document) by collecting obtained information units. Further, a series of operations of performing a series of document browsing and search keyword input to prepare at least one document is defined as an item session.

First, a user performs a start operation of the item session, and a system (after-mentioned related document display system 1000) recognizes this operation. On this occasion, the system numbers an item session ID (Identification). In an example in FIGS. 3A and 3B, the system numbers s2 as the item session ID.

Next, the user inputs the search keyword k1, browses search result pages, and refers to the document p1 likely related to an item from among the search result pages. The user stores the related event including the item session ID (s2), the related source (after-mentioned search source during the search) of the referred-to document p1, and the related destination (after-mentioned search destination during the search) of the search keyword k1 in the related event table 510 (related event storage unit). As for a class of the related event, p1 of the related source is denoted as p, and further, k1 of the related destination is denoted as k. In this class, k denotes a search keyword, and p denotes a document. Further, c of the class appearing later denotes a prepared document.

The user similarly performs a search based on the search keyword k2 to refer to the document p2 and performs a search based on the search keyword k3 to refer to the document p3, and therefore, similarly stores the documents in the related event table 510.

Further, the user refers to the document p1, and refers to the document p0 via a link in the document p1. For this transition between documents, p0 is stored in the related source of the related event table 510, and p1 is stored in the related destination thereof.

The user further prepares the document c1. Here, the user copies a text of a part of the document p0, and pastes the copied text into the document c1. For a relationship of this copy-paste (copy and paste), the user stores c1 as the related source and p0 as the related destination in the related event table 510. The user copies a text of a part of the document p2 and pastes the copied text into the prepared document c1, and therefore, similarly stores the text in the related event table 510. The user further refers to the document p3, but does not apply the document p3 to a preparation of the document c1.

Next, suppose that the user ends a preparation of the document c1 and stores the prepared document c1 in the content systematized server 200 (described below). The content systematized server 200 receives a storage of this prepared document c1, prepares a list of documents related to the document preparation in the item session s2, and stores the prepared list in the item session-classified available document list table 520. Concretely, with reference to the related event table 510, the content systematized server 200 searches a tree structure using the related events in the range of s2 as illustrated in arrows in FIG. 3, and prepares a list (item session-classified available document list table 520) of documents related to the document preparation. Here, k3 and p3 are not contained in a part of the tree structure using the related events accessible from c1, and therefore, not stored in the item session-classified available document list table 520, and excluded from an object useful for generating the related link at this point.

Next, the content systematized server 200 generates a related link between two arbitrary documents from among the related links in which a column value of the item session ID of the item session-classified available document list table 520 is s2 of the item session ID, and stores information on this related link in the related link management information 530 (related link storage unit). At this time, if the information is previously stored in the related link management information 530, one is added to a value of a counter. If the information is not previously stored in the related link management information 530, one is stored in a counter. By doing so, there is learned a document having high relevance related to the document preparation or relevance between the search keywords as a type of document.

Next, another processing at the time of performing the recommendation will be described. As illustrated in FIG. 3B, a case where a related search keyword is presented when a user inputs a search keyword will be described as an example. Suppose that a user inputs k1 as the search keyword. When the user inputs the search keyword k1, the content systematized server 200 searches the related link management information 530 for the related link in which a URI of the related source is k1 and a class of the related destination is k. In an example in FIG. 3, k2 is hit. The content systematized server 200 sorts the search result containing this search keyword k2 in descending order by the counter, and presents to the user the sorted results from a high order. This enables the user to perform a search and refer to the reference information from the new viewpoint of the search keyword k2 related to k1 but different therefrom.

### First Embodiment

### (Structure)

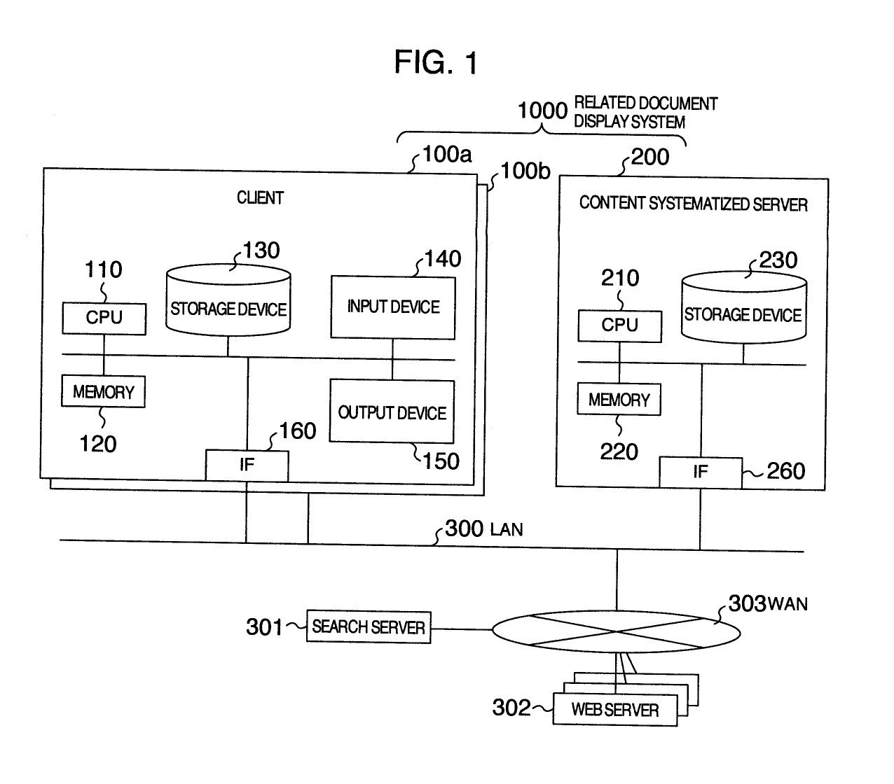

Next, a hardware structure of a related document display system according to the first embodiment will be described. As illustrated in FIG. 1, a related document display system 1000 according to the first embodiment includes one or more client computers (hereinafter, referred to as a “client”) 100 (“100” collectively names “100a” and “100b”, and hereinafter, much the same is true on the other structures) and a content systematized server 200, and they are connected to each other via a LAN 300. The LAN 300 is further connected to a search server 301 and a Web server 302 via a WAN (Wide Area Network) 303.

The client 100 is a computer device including a CPU (Central Processing Unit) 110, a memory 120, a storage device 130, an input device 140, an output device 150, and an IF (network interface controller) 160.

The CPU 110 is a processor that reads out and executes software stored in the memory 120. The CPU 110 executes software such as an operating system and an application program, thereby realizing a predetermined function.

The memory 120 stores software such as an operating system and an application program or various types of data read out from the storage device 130.

The storage device 130 is, for example, a disk drive or a magneto optical disk drive, and stores software such as an operating system and an application program or various types of data.

The input device 140 is, for example, a keyboard or a mouse. The input device 140 receives an input from a user.

The output device 150 is a display unit, and outputs information instructed by the CPU 110. The IF 160 is connected to the LAN 300. The client 100 may include a plurality of the IFs 160.

The content systematized server 200 is a computer including a CPU 210, a memory 220, a storage device 230, and an IF (network interface controller) 260.

The CPU 210 is a processor that reads out and executes software stored in the memory 220. The CPU 210 executes software, thereby realizing a predetermined function such as generation of relevance and presentation of related information.

The memory 220 stores software read out from the storage device 230.

The storage device 230 is, for example, a disk drive or a magneto optical disk drive, and stores software.

The IF 260 is connected to the LAN 300. The content systematized server 200 may include a plurality of the IFs 260.

Next, a description will be made on a hardware structure, a program for processing relevance generation and relevance presentation, and software illustrating one example of the related information that are stored in the memory 220 of the content systematized server 200 according to the first embodiment.

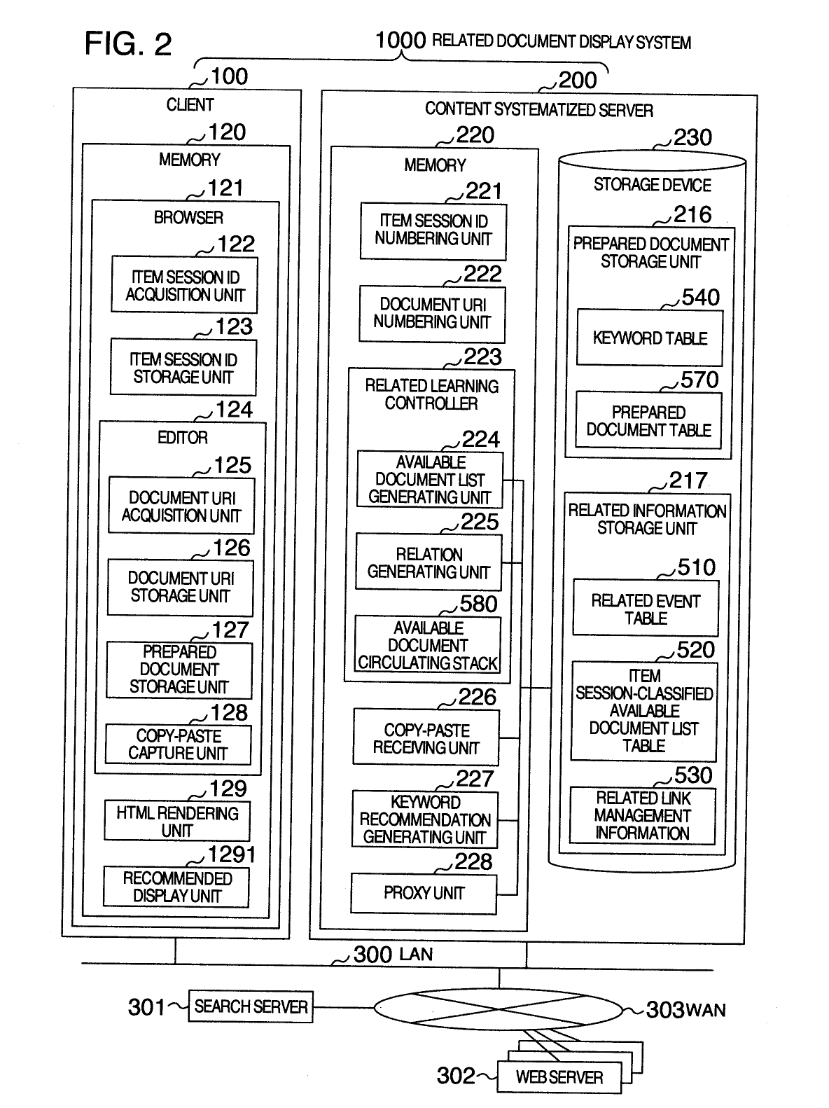

As illustrated in FIG. 2, the memory 220 stores an item session ID numbering unit 221, a document URI (Uniform Resource Identifier) numbering unit 222, a related learning controller 223, a copy-paste receiving unit 226, a keyword recommendation generating unit 227, and a proxy unit 228 (recommended controller). Further, the related learning controller 223 includes an available document list generating unit 224, a relation generating unit 225, and an available document circulating stack 580. Each unit within the memory 220 is a processing program, which is a program executed by the CPU 210 in FIG. 1. These processings will be described below.

Further, the storage device 230 stores a prepared document storage unit 216 and a related information storage unit 217. The prepared document storage unit 216 stores a keyword table 540 and a prepared document table 570. The related information storage unit 217 stores a related event table 510, an item session-classified available document list table 520, and a related link management information 530.

Next, a description will be made on one example of a software structure stored in the memory 120 of the client 100. The memory 120 of the client 100 stores a browser 121. The browser 121 stores an item session ID acquisition unit 122, an item session ID storage unit 123, an editor 124, an HTML (Hyper Text Markup Language) rendering unit 129, and a recommended display unit 1291. The editor 124 stores a document URI acquisition unit 125, a document URI storage unit 126, a prepared document storage unit 127, and a copy-paste capture unit 128. These processings will be described in detail below.

In the first embodiment, each of these units is assumed to be mounted as an advanced function of the browser 121 of the client 100. A configuration may be adopted in which a script such as Java (trademark) Script, for example, is added to a Web content received from the Web server 302 to implement the script on the browser 121 to provide a function in the proxy unit 228 that relays communication between the client 100 and the Web server 302.

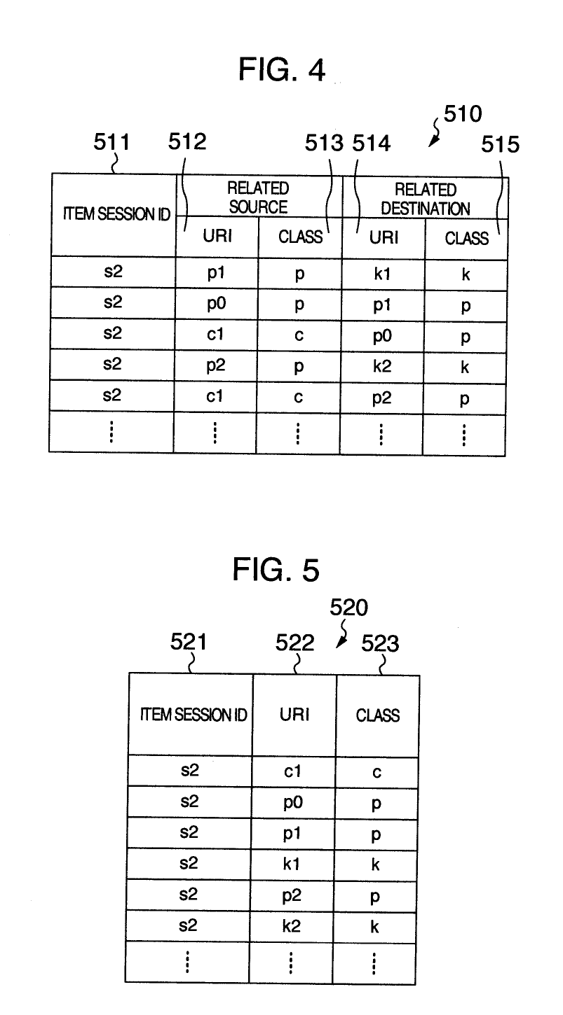

Next, each data structure will be described. The related event table 510 will be first described. As illustrated in FIG. 4, the related event table 510 holds a combination of information units of an item session ID 511, a URI 512 as a related source, a class 513 as a related source, a URI 514 as a related destination, and a class 515 as a related destination.

Next, the item session-classified available document list table 520 will be described. As illustrated in FIG. 5, the item session-classified available document list table 520 holds a combination of information units of an item session ID 521, a URI 522, and a class 523.

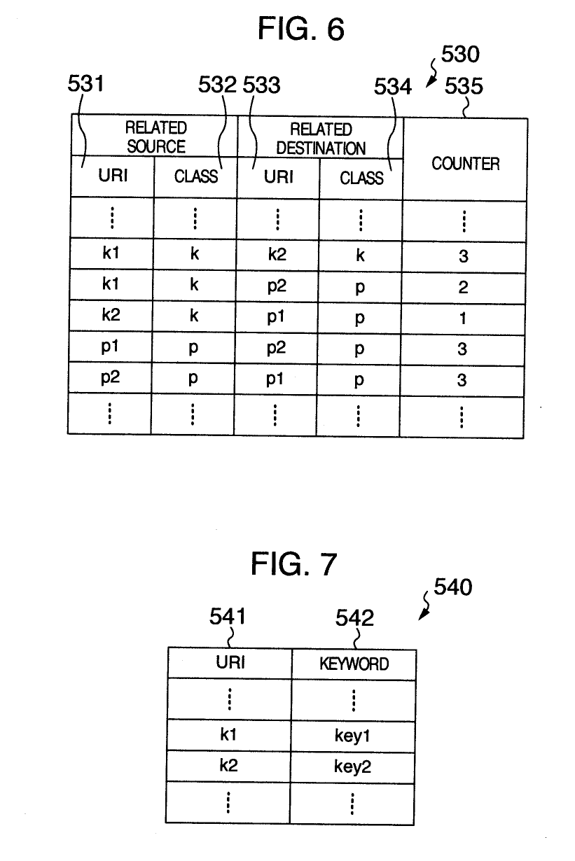

Next, the related link management information 530 will be described. As illustrated in FIG. 6, the related link management information 530 holds a combination of information units of a URI 531 as a related source, a class 532 as a related source, a URI 533 as a related destination, a class 534 as a related destination, and a counter 535.

Next, the keyword table 540 will be described. As illustrated in FIG. 7, the keyword table 540 holds a combination of information units of a URI 541 and a keyword 542.

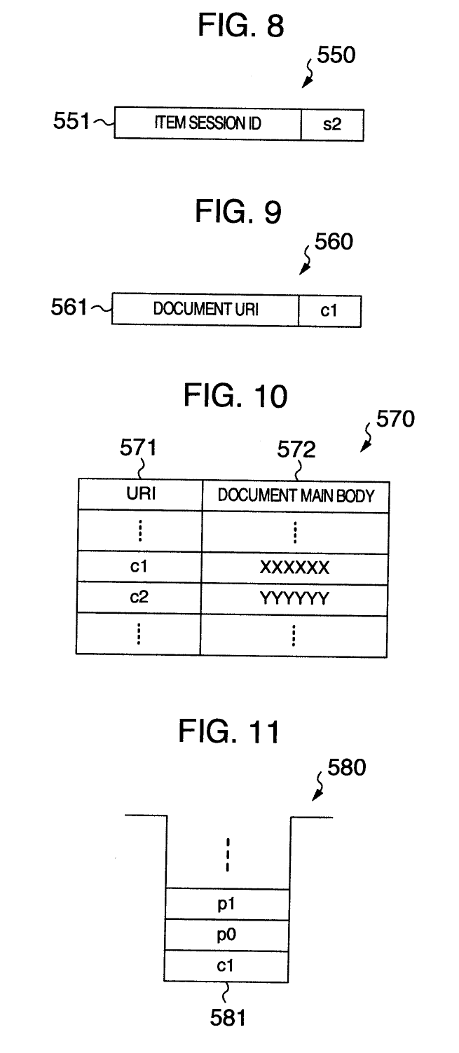

Next, an item session ID Cookie 550 will be described. As illustrated in FIG. 8, the item session ID Cookie 550 holds information on the item session ID 551. When a description will be further made with reference also to FIG. 2, the browser 121 generates the item session ID Cookie 550 based on the item session ID stored in the item session ID storage unit 123, and collectively transmits the item session ID Cookie 550 at the time of communicating with the content systematized server 200. This enables the content systematized server 200 to capture that each operation from the client 100 corresponds to one of which item session and to store its information in the item session ID 511 of the related event table 510.

Next, a document Cookie 560 will be described. As illustrated in FIG. 9, the document Cookie 560 holds information on a document URI 561. When a description will be further made with reference also to FIG. 2, the browser 121 generates the document cookie 560 based on the document URI stored in the document URI storage unit 126, and the prepared document storage unit 127 collectively transmits this document Cookie 560 at the time of transmitting the prepared document to the content systematized server 200. This enables the content systematized server 200 to capture the document URI of the prepared document and to store its information in the prepared document table 570.

Next, the prepared document table 570 will be described. As illustrated in FIG. 10, the prepared document table 570 holds a combination of information units of a URI 571 and a document main body 572.

Next, the available document circulating stack 580 will be described. As illustrated in FIG. 11, the available document circulating stack 580 holds information on an available document URI 581.

### (Processing)

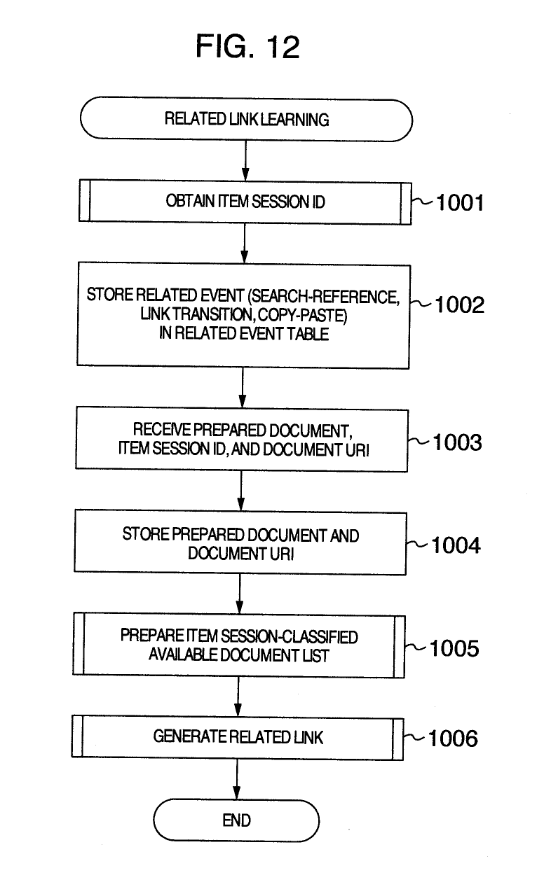

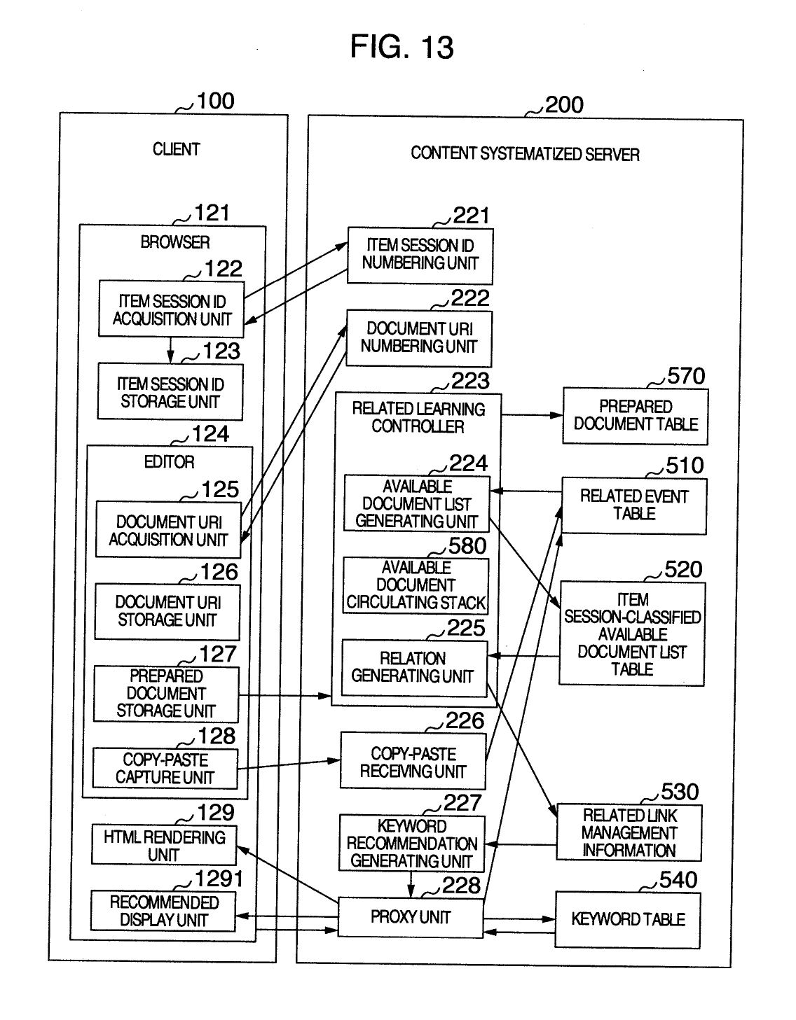

A processing of the related link learning will be described in detail below. Operation images of the entire flow and relationships between respective units of the client 100 and the content systematized server 200 will be first described with reference to FIGS. 12 and 13. In the same manner as in a general server, actually, the content systematized server 200 receives various types of requests from the client 100 and operates in an event-driven manner. Therefore, a series of operations illustrated in FIG. 12 is not actually present as a procedure if nothing is done, and executed on a piecemeal basis. A processing of the related link learning is executed in this order by the interaction with the client 100.

As illustrated in FIGS. 12 and 13, the item session ID acquisition unit 122 obtains an item session ID from the item session ID numbering unit 221 to store the obtained item session ID in the item session ID storage unit 123 (step 1001).

Thereafter, the content systematized server 200 stores as a related event a relevance formed using operations of a user by the interaction with the client 100 (step 1002). In step 1002, actually, a processing depending on a plurality of related event capture units is repeatedly executed asynchronously with each other. Concretely, the related event includes a search keyword-reference page, a link transition (page transition using a link reference), and a copy-paste.

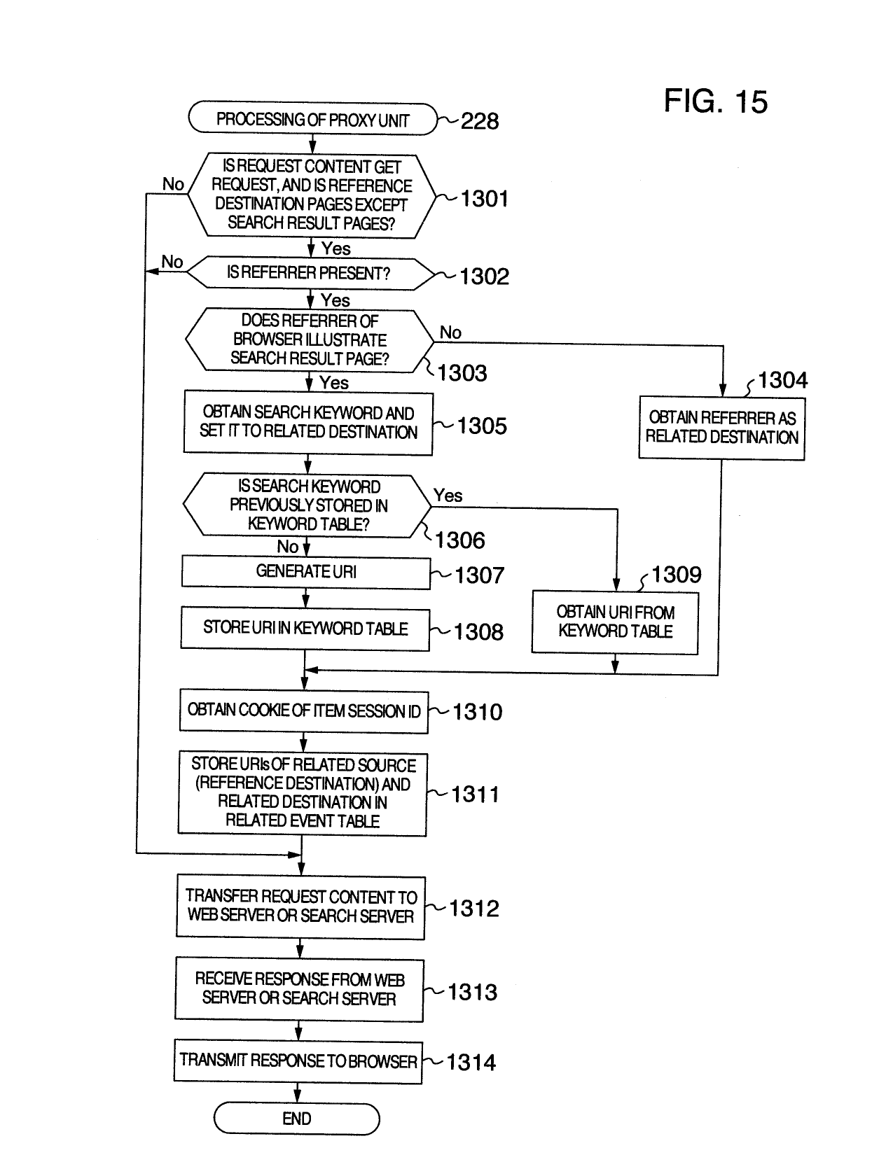

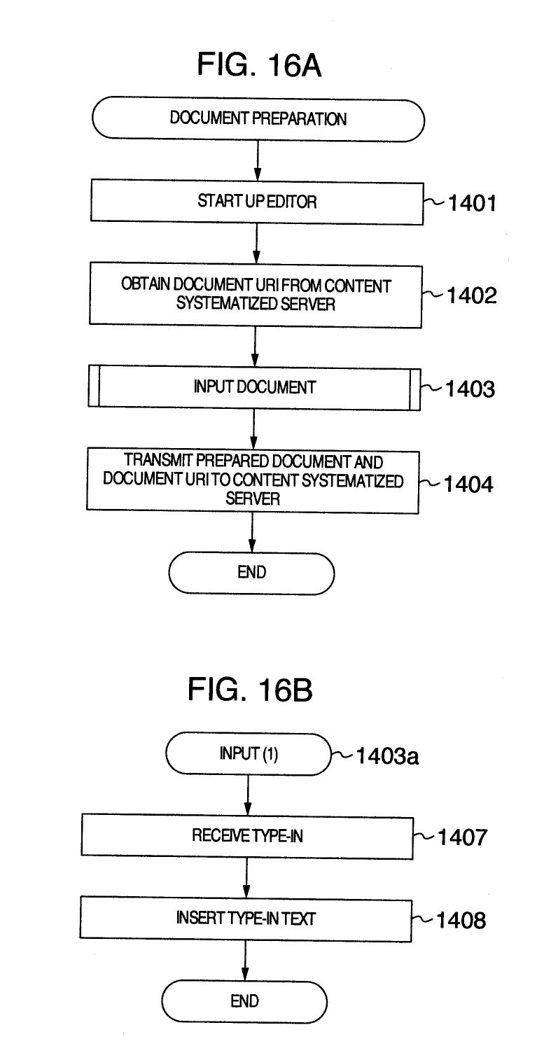

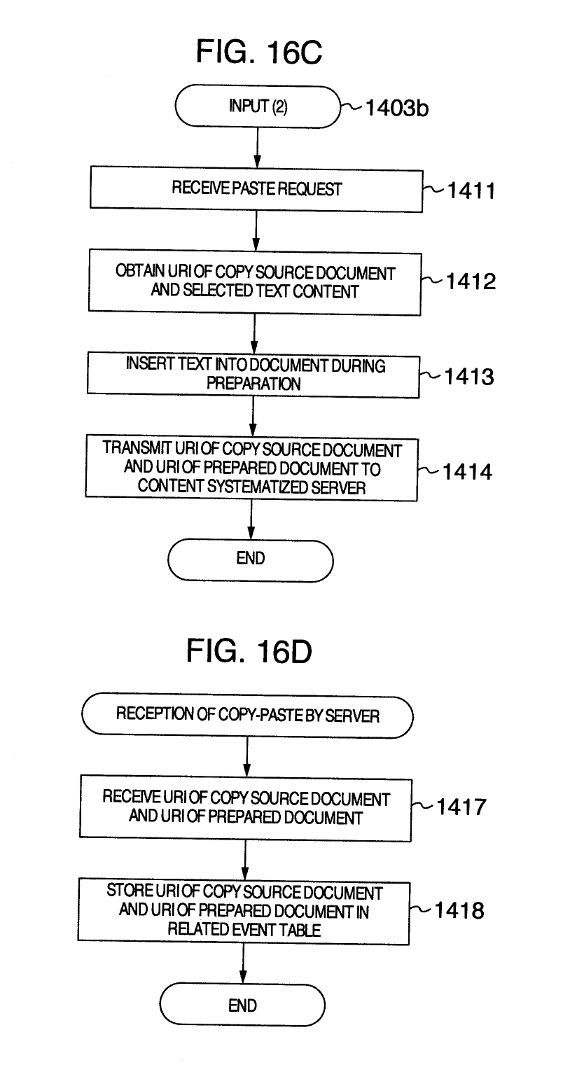

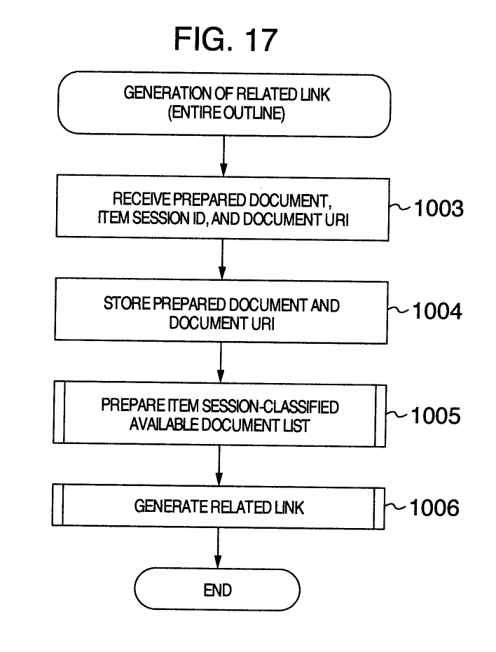

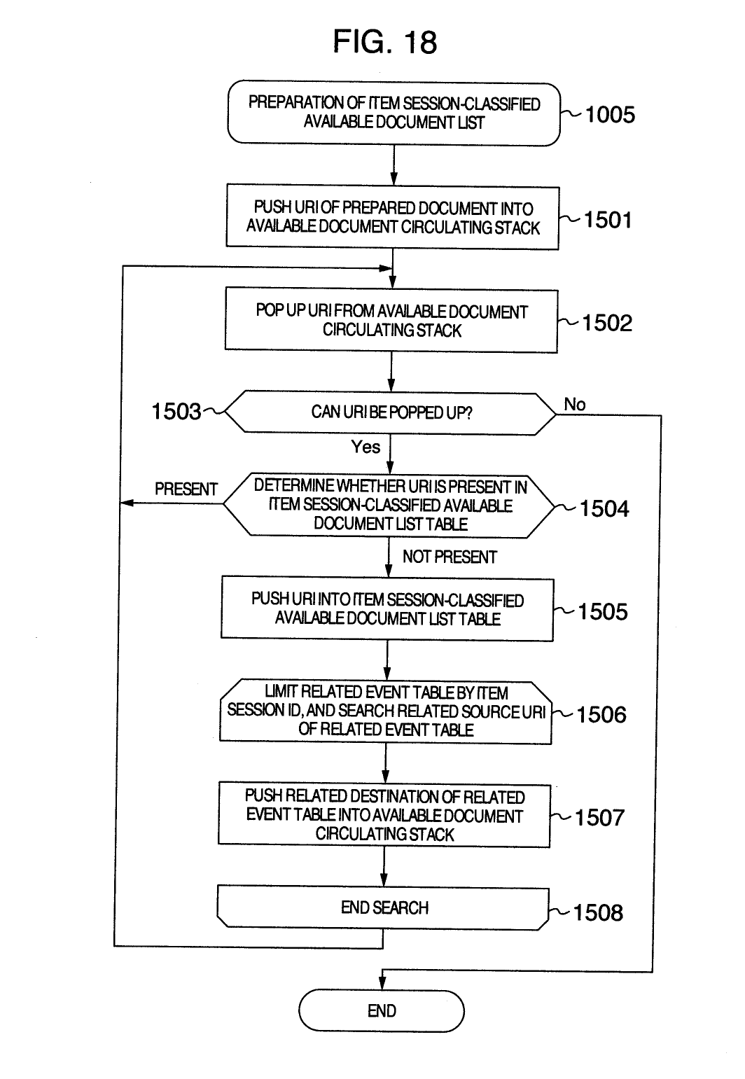

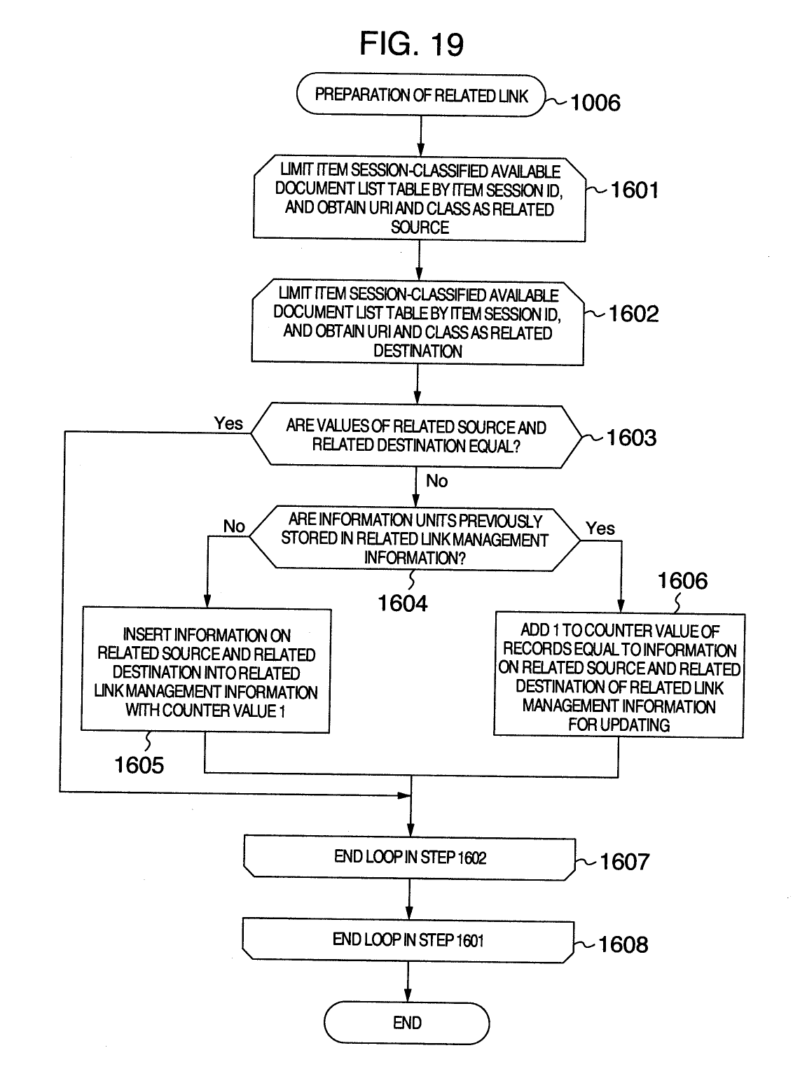

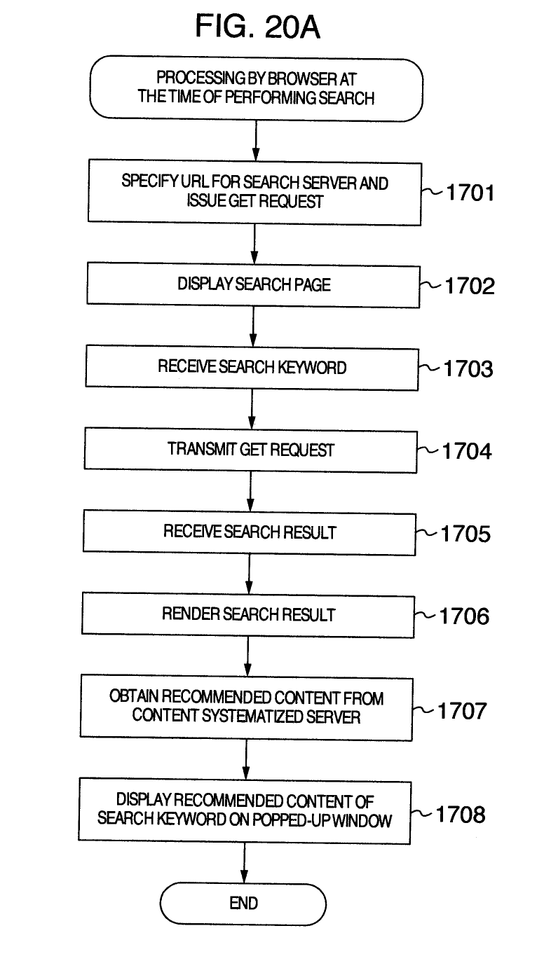

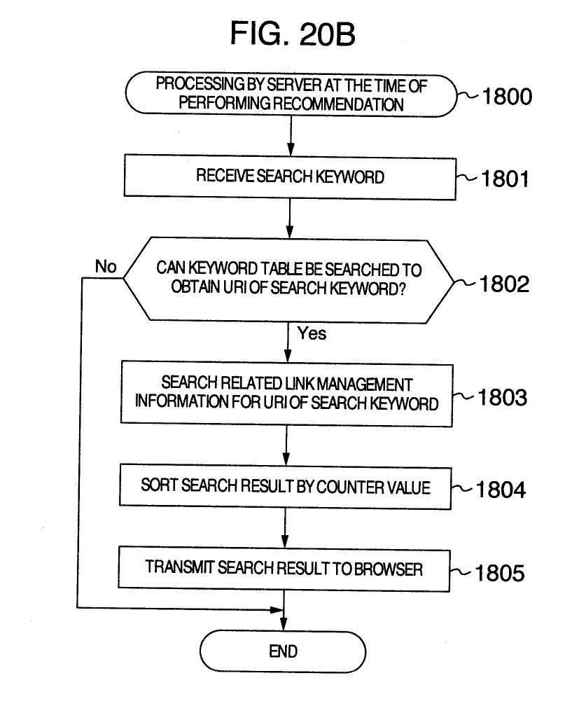

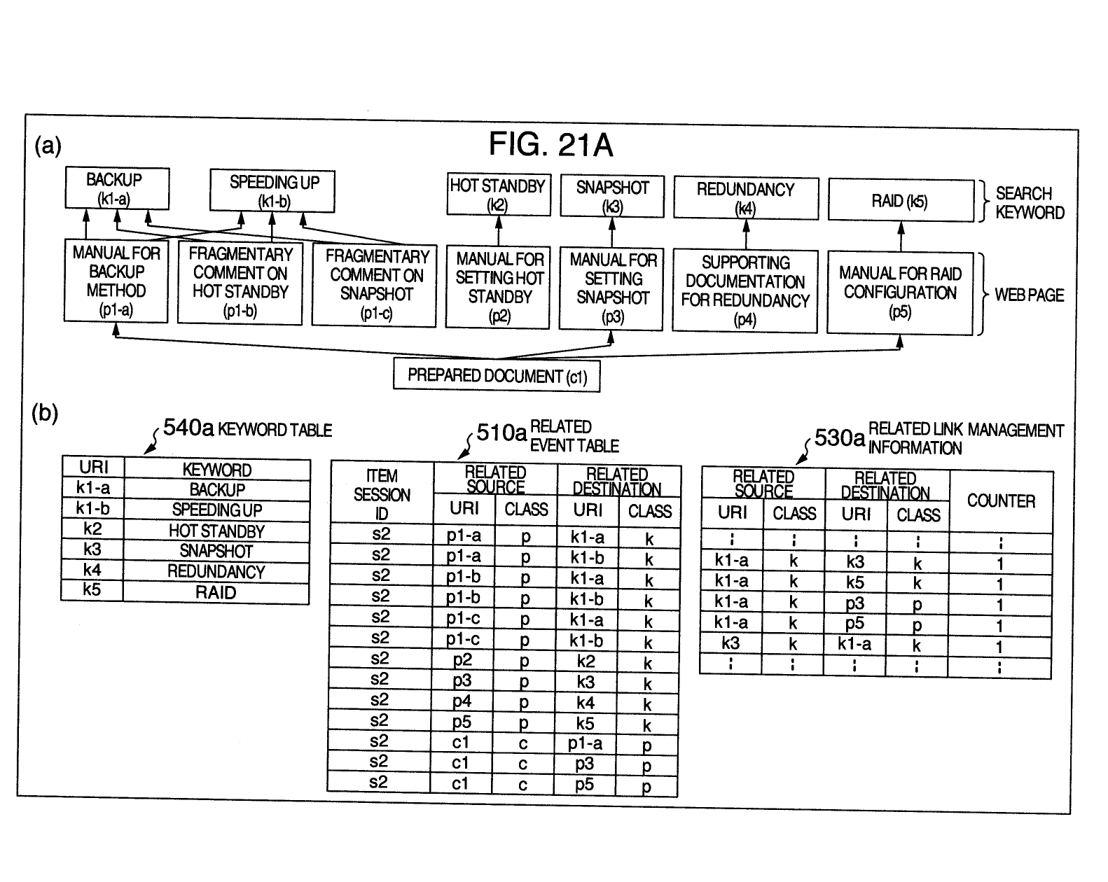

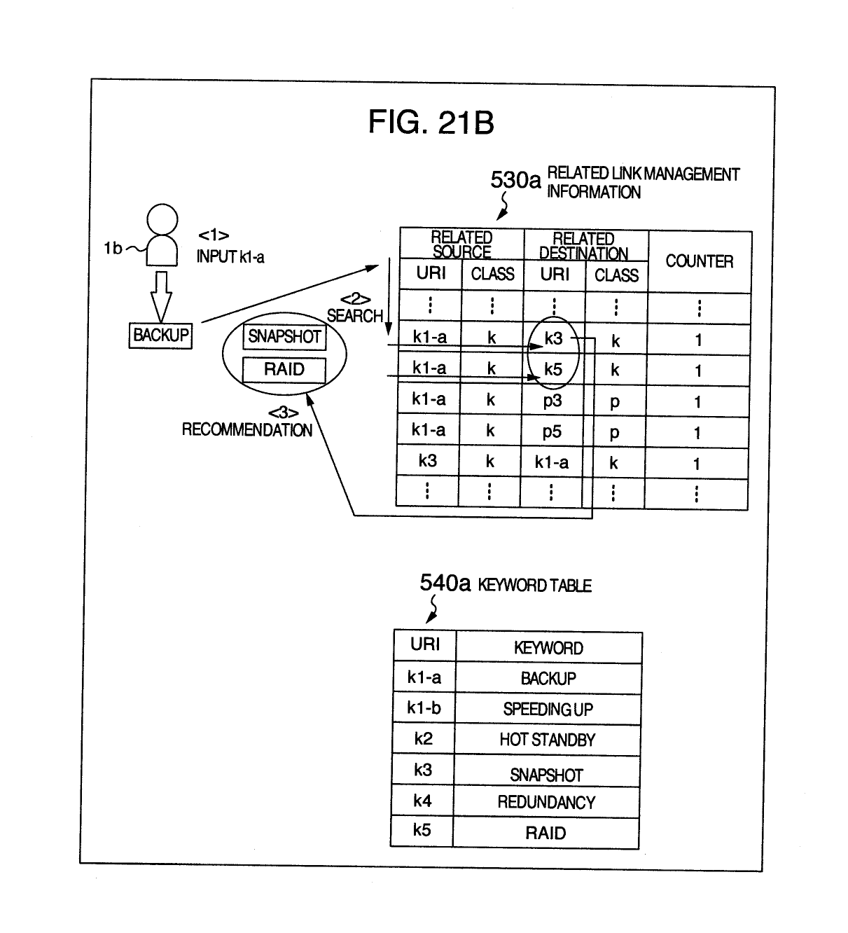

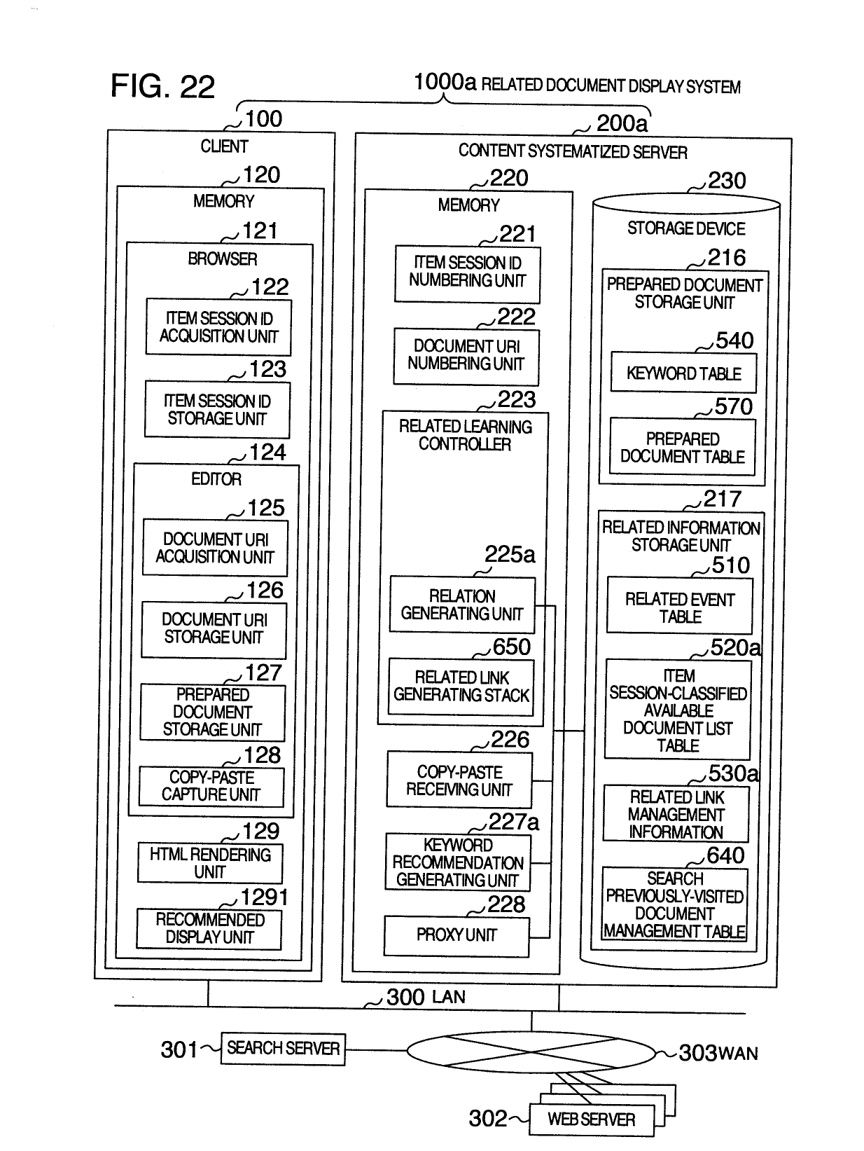

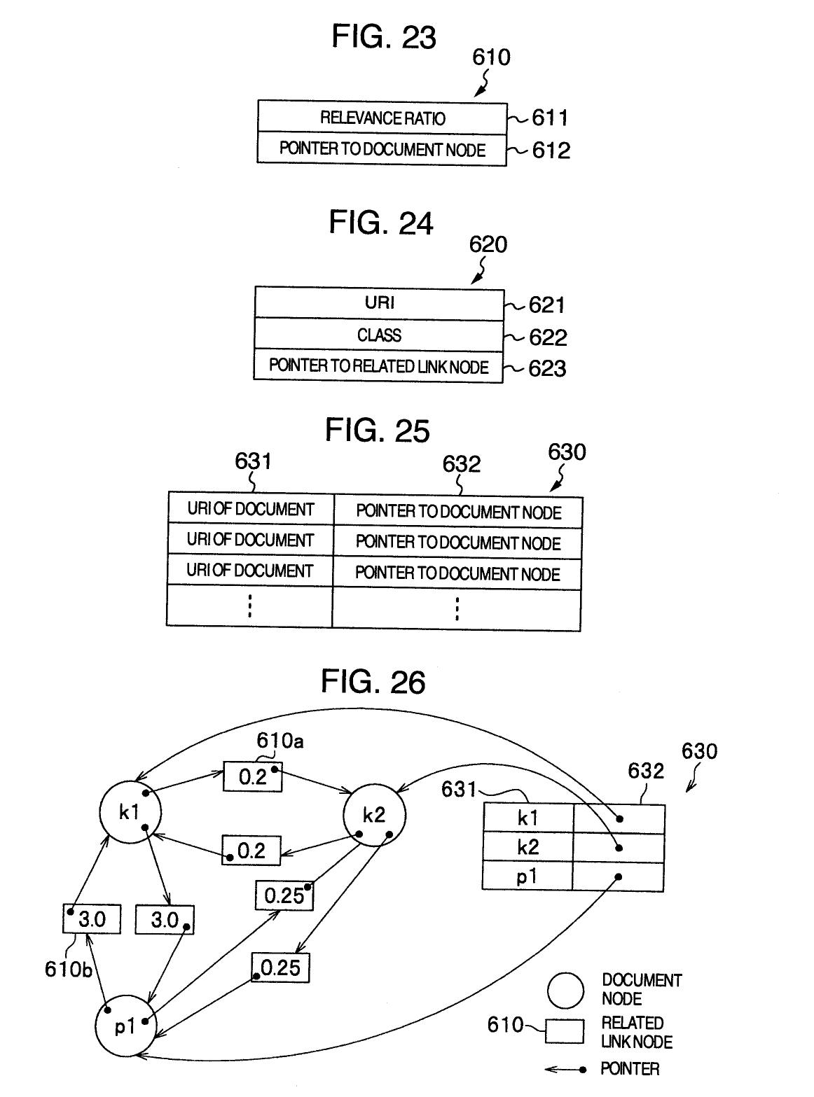

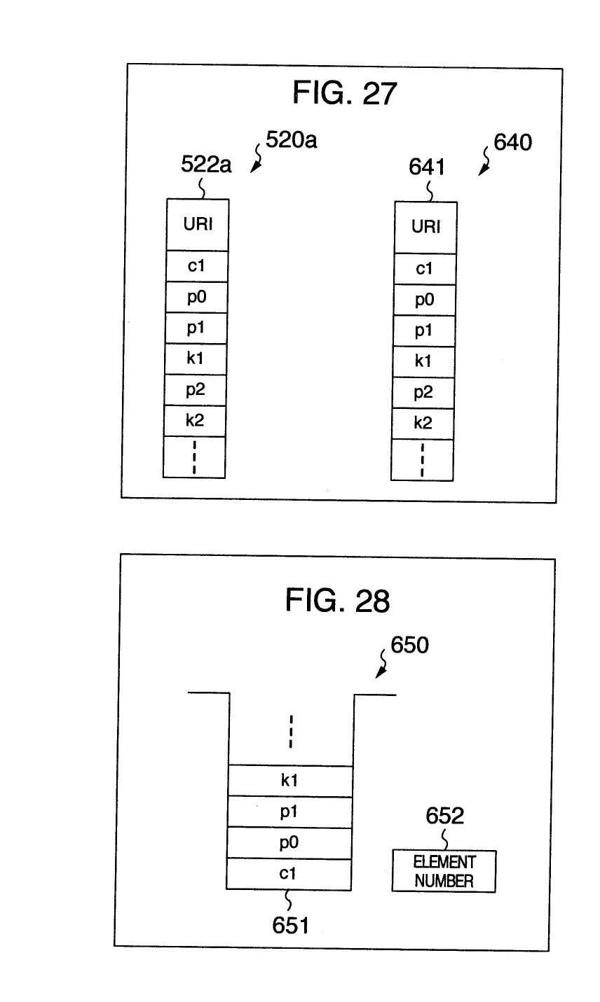

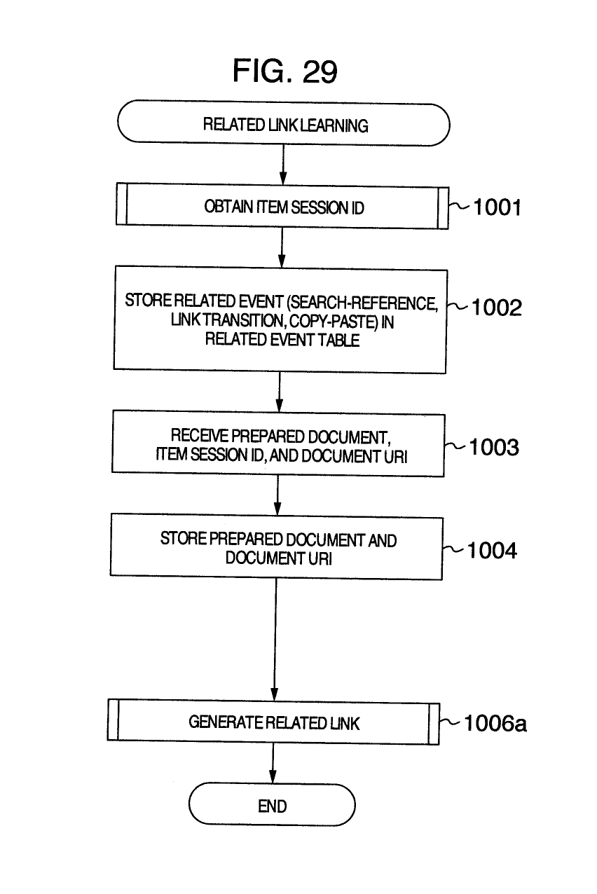

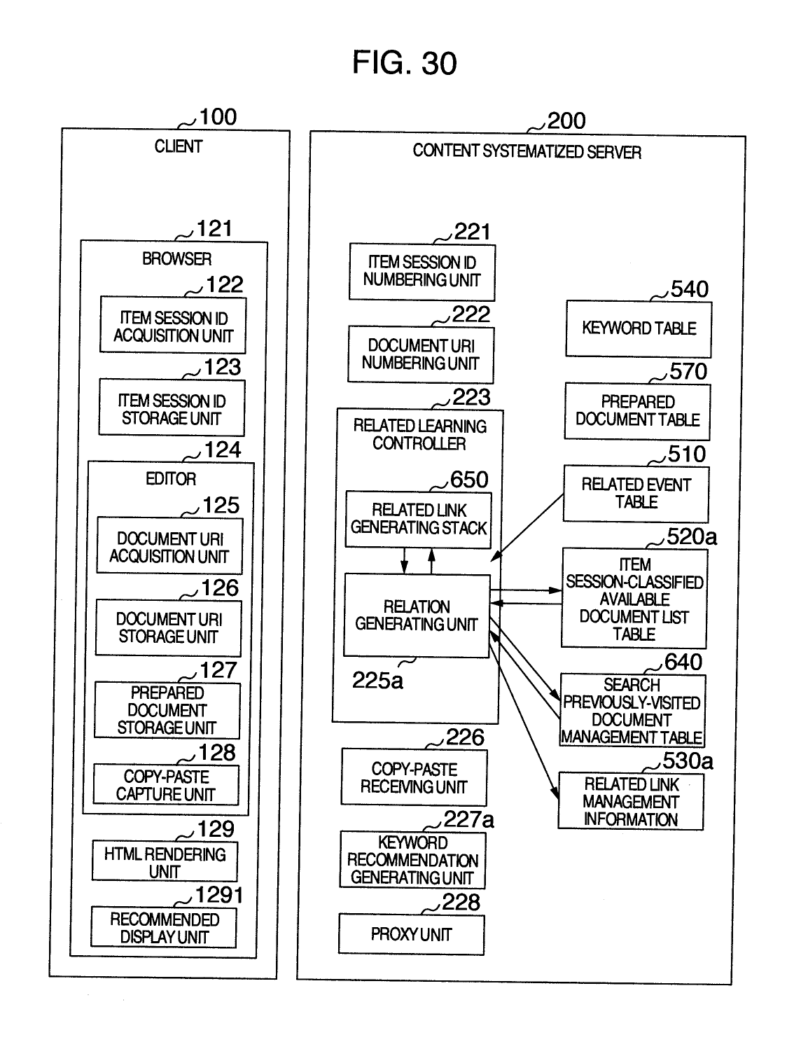

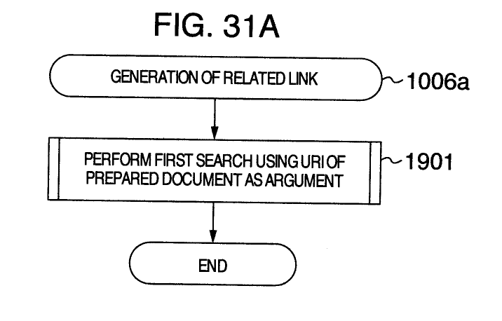

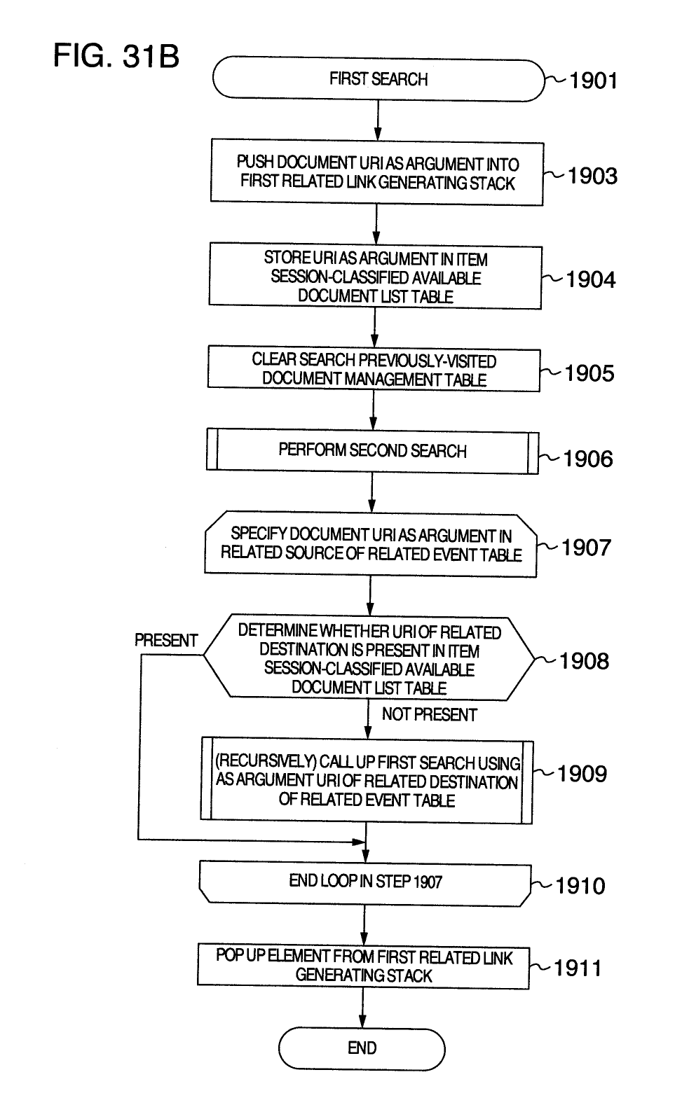

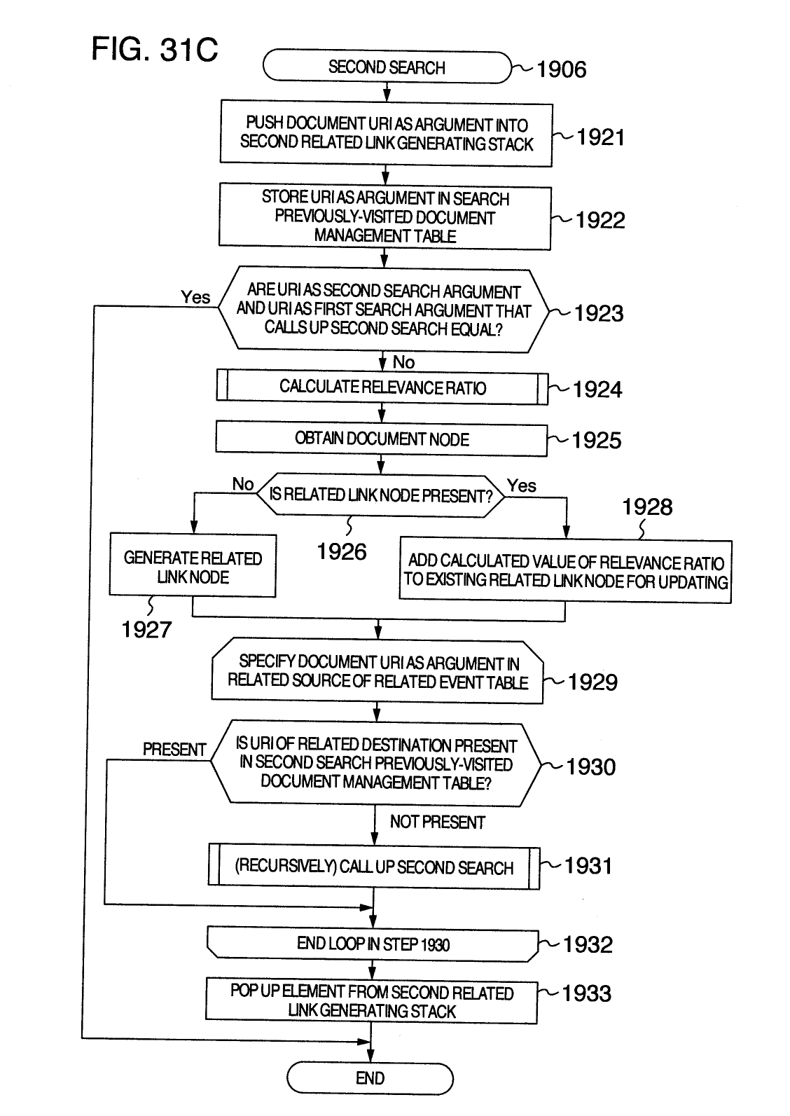

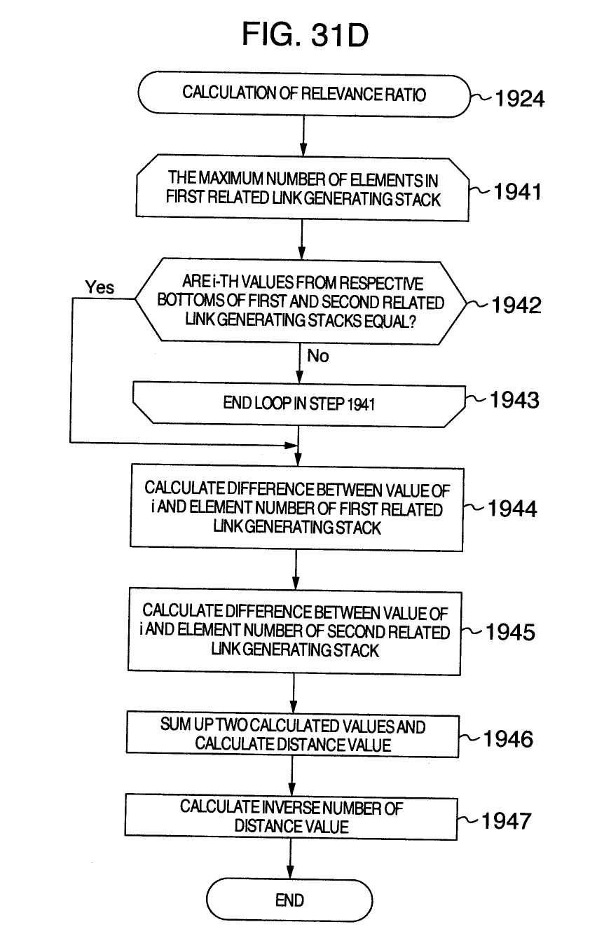

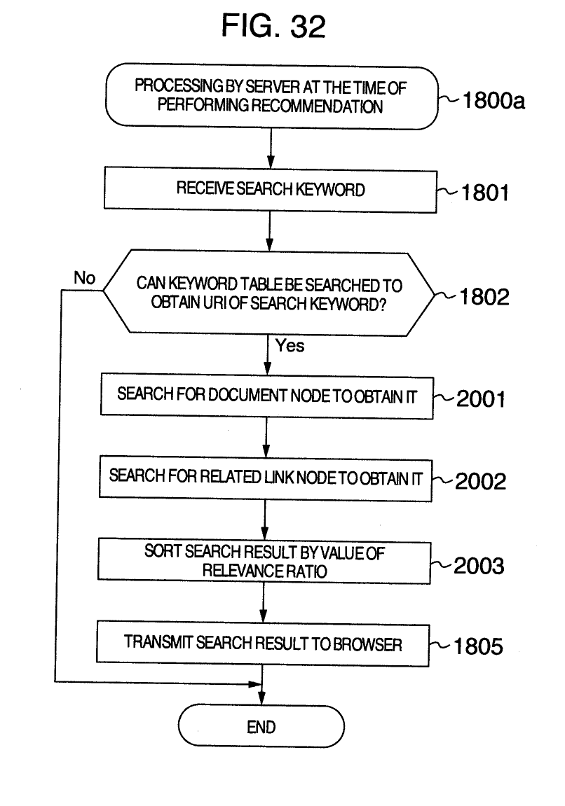

As for the related event of the search keyword-reference page, the client 100 first transmits to the proxy unit 228 the related event containing a search request and reference from the browser 121, and the proxy unit 228 refers to the keyword table 540 and then stores the received related event in the related event table 510. As for the link transition, the client 100 transmits to the proxy unit 228 the related event containing a request of the link transition from the browser 121, and the proxy unit 228 stores this received related event in the related event table 510. As for the copy-paste, the client 100 transmits the related event containing a content captured by the copy-paste capture unit 128 to the copy-paste receiving unit 226, which stores the received related event in the related event table 510. Processings on these related events will be described in detail below with reference to FIGS. 15, 16C, and 16D.

Next, the prepared document storage unit 127 transmits the prepared document, the item session ID, and the document URI to the related learning controller 223, which receives them (step 1003). Suppose that the item session is ended by this process in step 1003. The related learning controller 223 stores the transmitted prepared document and document URI in the prepared document table 570 (step 1004). This causes the prepared document to be registered (stored) and the related link between documents to be generated.

After the registration of the prepared document (step 1004), the available document list generating unit 224 prepares the item session-classified available document list (step 1005). That is, the available document list generating unit 224 extracts a document from the related event table 510 while following the related events in sequence by beginning at the registered prepared documents in the present range of the item sessions. Further, the available document list generating unit 224 prepares a list of available documents in the item session among accessed documents using the available document circulating stack 580, and stores the prepared list in the item session-classified available document list table 520.

Subsequently, the relation generating unit 225 generates a related link (step 1006). That is, the relation generating unit 225 refers to the item session-classified available document list table 520, and generates a related link between both arbitrary item session-classified available documents to store the generated related link in the related link management information 530. As a result, the related link is learned as the available document for each item session.

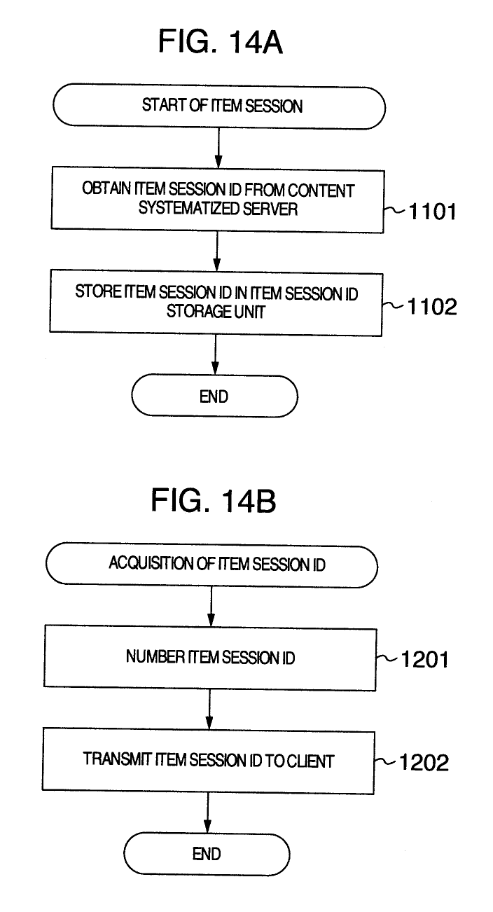

Each step will be described in detail below. As for a detailed acquisition processing of the item session ID in step 1001 in FIG. 12, operations on the client 100 side and those on the content systematized server 200 side will be described, respectively, with reference to FIGS. 14A and 14B.

FIG. 14A illustrates one example of a process flow by the item session ID acquisition unit 122 executed by the client 100 according to the first embodiment.

As illustrated in FIG. 14A, the item session ID acquisition unit 122 first requests the item session ID to the item session ID numbering unit 221 of the content systematized server 200 to obtain the item session ID (step 1101). Next, the item session ID acquisition unit 122 stores the item session ID obtained in step 1101 in the item session ID storage unit 123 (step 1102).

FIG. 14B illustrates one example of a process flow by the item session ID numbering unit 221 executed by the content systematized server 200 according to the first embodiment.

As illustrated in FIG. 14B, the item session ID numbering unit 221 first receives a request from the item session ID acquisition unit 122 in step 1101 in FIG. 14A and numbers the item session ID (step 1201). Next, the item session ID numbering unit 221 transmits the item session ID numbered in step 1201 to the item session ID acquisition unit 122 of the client 100 as a source of request (step 1202).

Next, a processing in which the related event is stored in the related event table 510 in step 1002 in FIG. 12 will be described in detail. As described above, the related event includes a search keyword-reference page, a link transition, and a copy-paste.

Capture and storage of the related event of the search keyword-reference page will be first described with reference to FIGS. 15 and 2. The related events of the search keyword-reference page and the link transition are partially obtained and stored by a processing of the proxy unit 228.

(Process of a Case in which a Transition from other Web Pages is not Present)

A process flow of a case in which a transition from other Web pages is not present and in which the browser 121 refers to a Web page by a direct input of a URL (Uniform Resource Locator) to an address bar or by a selection of a book mark will be first described. An initial page transition among link transitions (page transition using a link reference) in which the related event is not captured but the related event to be captured is present in the case of this process flow will be first described as a premise. Further, the GET request described below is one of general requests in an HTTP (Hyper Text Transfer Protocol) as a general protocol, and an acquisition request of a Web page to the Web server 302 from the browser 121.

The proxy unit 228 determines whether a request content from the browser 121 is the GET request and a reference destination is all pages except search result pages (step 1301). Here, since a Web page reference request is the GET request and the reference destination is all pages except search result pages (YES in step 1301), the proxy unit 228 goes to step 1302.

In step 1302, the proxy unit 228 determines whether a referrer (page as a link source) is present in a request from the browser 121. Here, since a referrer is not present in the request from the browser 121 because a reference from the browser 121 is not a transition from other Web pages (NO in step 1302), the proxy unit 228 goes to step 1312.

Next, the proxy unit 228 transfers the GET request to the Web server 302 (step 1312).

Subsequently, the proxy unit 228 receives a response to the GET request from the Web server 302 (step 1313), and transmits the received response to the browser 121 (step 1314), thereby ending the process.

(Process of a Case in which a Transition from other Web Pages is Present)

Next, a process flow of a case in which a transition between pages having captured therein the related event is present will be described. In this case, the browser 121 follows a link in a page to refer to another page.

In the case, in the same manner as in the process flow of the case in which a transition from other Web pages is not present, the proxy unit 228 goes up to step 1302. In step 1302, the proxy unit 228 determines that the referrer is present in the request from the browser 121 (YES), and goes to step 1303.

In step 1303, the proxy unit 228 determines whether the referrer of the browser 121 illustrates the search result page. Here, since a reference from the browser 121 is a transition from the other Web pages, a determination result in step 1303 is NO, and the proxy unit 228 goes to step 1304.

Next, the proxy unit 228 obtains the referrer as the related destination (step 1304).

Subsequently, the proxy unit 228 obtains a value of the item session ID Cookie 550 contained in a request from the browser 121 so as to capture the fact that a request from the browser 121 is one from which item session (step 1310).

Next, the proxy unit 228 stores in the related event table 510 the related event including the item session ID, the related source of a reference destination URI, and the related destination obtained in step 1304 as the related destination (step 1311). Each class of the related source and the related destination of the related event is denoted as p.

Further, the proxy unit 228 goes to step 1312. Hereinafter, since process operations from step 1312 to step 1314 are the same as the above-described process operations, the description will be omitted here.

In addition, in the present embodiment, the content systematized server 200 is assumed to obtain a transition between pages using a referrer; however, there may be adopted a configuration in which the browser 121 of the client 100 obtains information when a user clicks a hyperlink of the Web page.

(Process of the Case in which an Arbitrary Web Page is Selected from Search Results to Transit a Page)

Next, a method for capturing the related event between a search keyword and a reference document in the case in which the search server 301 performs a search from the browser 121 and selects an arbitrary Web page from the search results to transit a page will be described with reference to FIGS. 15 and 2.

First, the proxy unit 228 goes to step 1301. The browser 121 here receives an input of the search keyword by a user to perform a search. Since the browser 121 contains the search keyword in a parameter of URL to perform the GET request to a search page (i.e., the reference destination is a search result page), a determination result of the proxy unit 228 in step 1301 is NO, and the proxy unit 228 goes to step 1312.

The proxy unit 228 transfers the search request to the search server 301 (step 1312), and receives a response from the search server 301 (step 1313). At this time, a URL parameter of the response from the search server 301 contains the search keyword. Subsequently, the proxy unit 228 transmits the response to the browser 121 (step 1314). This process flow illustrates operations at the time when the browser 121 performs a search. At this time, the browser 121 obtains a search result page, and a user can browse the obtained search result page. This search result page is a Web page (not shown) in which the search results are displayed as a list when the search is performed in general search pages (not shown).

(Processing of the Case in which an Arbitrary Web Page is Selected from Search Result Pages)

Next, suppose that a user selects an arbitrary Web page from search result pages by the browser 121 to issue a reference request to the proxy unit 228. The proxy unit 228 executes a process illustrated in FIG. 15 again, and goes to step 1301 as described above. Here, since selecting the arbitrary Web page from the search result pages, the browser 121 issues the GET request of Web pages except the search result pages (YES in step 1301), and the proxy unit 228 goes to step 1302.

Here, since the referrer shows the search result pages, determinations in steps 1302 and 1303 are YES, and the proxy unit 228 goes to step 1305. The proxy unit 228 obtains a search keyword from a parameter of the referrer to set the obtained search keyword to the related destination (step 1305).

Next, the proxy unit 228 determines whether the obtained search keyword is previously stored in any one of the keyword 542 of the keyword table 540 (refer to FIG. 7) (step 1306). If NO in step 1306, the proxy unit 228 goes to step 1307 and generates a URI to the search keyword.

After step 1307, the proxy unit 228 stores a combination of the search keyword and the generated URI in the keyword table 540 (step 1308). Meanwhile, if YES in step 1306, the proxy unit 228 refers to the keyword table 540 to obtain a URI corresponding to the search keyword (step 1309).

After step 1308 or 1309, the proxy unit 228 obtains a value of the item session ID Cookie 550 contained in a request from the browser 121 in order to capture the fact that a request from the browser 121 is one from which item session (step 1310), and the proxy unit 228 goes to step 1311.

In step 1311, the proxy unit 228 stores in the related event table 510 the related event including the item session ID, the related source of the reference destination URL in which a user issues a reference request, and the related destination of the search keyword URI. A class of the related destination of the related event is denoted as k, and a class of the related source of the related event is denoted as p. Hereinafter, since a processing from step 1312 to step 1314 is the same as in the above-mentioned processing, a description will be omitted.

(Processing of the Case in which Copy-Paste is Performed)

As for the related event of copy-paste, the copy-paste receiving unit 226 receives the related event captured by the copy-paste capture unit 128 of the editor 124, and stores the received related event in the related event table 510. A processing in which the related event of this copy-paste is captured and stored will be described in detail with reference to FIGS. 16A, 16B, 16C, and 16D.

FIG. 16A illustrates one example of a process flow in which a document is prepared by the editor 124 of the client 100.

Preparation, editing, and storage of new documents in the editor will be first described on the premise of a description of copy-paste.

First, the editor 124 starts up editor (editing software) (step 1401).

Next, the editor 124 causes the document URI acquisition unit 125 to request the document URI numbering unit 222 of the content systematized server 200 to number a prepared document and newly obtain a URI for the prepared document (step 1402).

Subsequently, the editor 124 inputs a document (step 1403). A processing content of the document input in step 1403 will be described in detail with reference to FIGS. 16B and 16C. One process or a plurality of processes illustrated in FIGS. 16B and 16C are performed in the processing of the document input in step 1403. Then, the editor 124 causes the prepared document storage unit 127 to transmit a prepared document and a document URI to the content systematized server 200 (step 1404), and ends the process.

Next, editing using the copy-paste and capture and storage of the related event will be described.

FIG. 16C illustrates one example of a process flow in step 1403 in FIG. 16A. The editor 124 receives a paste request from a user (step 1411), and obtains a URI of a copy source document and a selected text as a paste content (step 1412). The copy source text is selected by a drug operation of a mouse, and a description will not be described in detail here because of a general function of the browser.

Next, the editor 124 inserts the obtained text into a document during the preparation by the instruction of a user (step 1413). Subsequently, the editor 124 transmits the copy source document URI and the prepared document URI to the copy-paste receiving unit 226 of the content systematized server 200 (step 1414), and ends the editing using the copy-paste.

Next, operations of the copy-paste receiving unit 226 that receives the copy source document URI and the prepared document URI from the editor 124 in the step 1414 will be described with reference to FIG. 16D. The copy-paste receiving unit 226 stores the received copy source document URI and prepared document URI in the related event table 510, respectively.

In step 1417, the copy-paste receiving unit 226 first receives the copy source document URI and the prepared document URI (step 1417). Next, the copy-paste receiving unit 226 stores in the related event table 510 the related event including the related destination of the copy source document URI and the related source of the prepared document URI (step 1418). In addition, a class of the related destination of the related event is denoted as p, and a class of the related source of the related event is denoted as c.

Next, the related event to be obtained is not present, and a processing content of a user type-in document editing that is a fundamental operation of the editor 124 will be described below.

FIG. 16B illustrates one example of a process flow 1403a in step 1403 in FIG. 16A. The editor 124 receives the type-in from the user (step 1407), and inserts the type-in text content into a prepared document (step 1408).

Further, except for a method for obtaining the related event described before now, the related event may be obtained from a description content of the prepared document as follows. Explicit link information such as a URL of a Web page in the prepared document and a document URI number, for example, may be extracted using the pattern recognition, and captured and stored as the related event including the related source of the prepared document and the related destination of a document of a link destination.

A processing of receiving a process in step 1404 and generating the related link in step 1003 and subsequent steps in FIG. 12 will be described in detail below.

### (Generation Processing of Related Link)

The entire process flow of a generation processing of the related link will be first described with reference to FIG. 17.

The related learning controller 223 receives the prepared document, the item session ID, and the document URI from the prepared document storage unit 127 (step 1003).

Next, the related learning controller 223 stores the prepared document and the document URI in the prepared document table 570 (step 1004). This causes the prepared document to be registered and the related link between documents to be generated.

Next, the related learning controller 223 starts up the available document list generating unit 224, which extracts a document while following the related events in the range of the present item sessions by beginning at the registered prepared documents to prepare an available document list in the item session among accessed documents (step 1005). This processing content in step 1005 will be described in detail below with reference to FIG. 18.

Subsequently, the related learning controller 223 starts up the relation generating unit 225, which generates a related link between both arbitrary item session-classified available documents (step 1006), and ends the process. This enables the related link to be learned as an available document for each item session. This processing content in step 1006 will be described in detail below with reference to FIG. 19.

### (Processing in Step 1005)

A processing (processing in step 1005) that is realized by the available document list generating unit 224 and in which an item session-classified available document list is prepared will be described.

As illustrated in FIG. 18, the available document list generating unit 224 first pushes a URI of the received prepared document into the available document circulating stack 580 (step 1501).

Next, the available document list generating unit 224 pops up the URI from the available document circulating stack 580 (step 1502), and determines whether to succeed in the pop (step 1503). If YES in step 1503, the available document list generating unit 224 determines whether the URI popped up in step 1502 is present in the item session-classified available document list table 520 (step 1504).

If NO in step 1504, the available document list generating unit 224 inserts the URI into the item session-classified available document list table 520 (step 1505), and goes to step 1506. Meanwhile, if YES in step 1504, the available document list generating unit 224 returns to step 1502.

In step 1506, the available document list generating unit 224 limits the related event table 510 by the item session ID, and searches the related source URI 512 of the related event table 510 for the URI popped up in step 1502. Whenever hitting the URI in the search, the available document list generating unit 224 pushes into the available document circulating stack 580 a value of the related destination URI 514 of records of the related event table 510 hit in step 1507. If the search is completed, the available document list generating unit 224 returns to step 1502 from step 1508. If the available document list generating unit 224 repeats these processings and cannot pop up the URI 581 from the available document circulating stack 580 in step 1503, namely, if the available document circulating stack 580 is empty, the available document list generating unit 224 ends the process.

### (Processing of Step 1006)

A processing that is realized by the relation generating unit 225 and in which the related link is generated between both of the arbitrary item session-classified available documents will be described. As illustrated in FIG. 19, the relation generating unit 225 limits the item session-classified available document list table 520 by the item session ID, and obtains a URI and a class as the related source in step 1601.

Next, the relation generating unit 225 limits the item session-classified available document list table 520 by the item session ID in step 1601, and obtains a URI and a class as the related destination in step 1602. Next, the relation generating unit 225 determines whether contents (values) of the related source and the related destination obtained in steps 1601 and 1602 are equal to each other (step 1603).

Next, if NO in step 1603, the relation generating unit 225 goes to step 1604 and determines whether information units on the related source and the related destination are previously stored in the related link management information 530. If NO in step 1604, the relation generating unit 225 goes to step 1605. In step 1605, the relation generating unit 225 inserts the information units on the related source and the related destination into the related link management information 530 with a counter value “1”. Meanwhile, if YES in step 1604, the relation generating unit 225 goes to step 1606. In step 1606, the relation generating unit 225 adds “1” to a counter value of records equal to the information units on the related source and the related destination of the related link management information 530 for the updating. The relation generating unit 225 generates the related links between all of two arbitrary available documents in the item session-classified available document list table 520 through a double loop composed of steps 1601 to 1608 and steps 1602 to 1607. That is a detailed processing of the related link learning.

### <<Processing at the Time of Performing Recommendation>>

Next, another processing at the time of performing a recommendation according to the present embodiment will be described in detail. Here, suppose a stage in which when the browser 121 of the client 100 receives an input of the search keyword for search, the content systematized server 200 presents a search keyword related to the search keyword.

### (Processing at the Time of Receiving Recommendation of Search Keyword)

A process flow by the browser 121 of the client 100 at the time of receiving a recommendation of the search keyword will be first described. As illustrated in FIG. 20A, the browser 121 specifies a URL for the search server and issues a GET request (step 1701), and displays a page for search (step 1702).

Next, the browser 121 receives a search keyword from a user (step 1703), and contains the search keyword in a parameter of the URL to transmit the GET request to the content systematized server 200 (step 1704).

Next, the browser 121 receives search results from the content systematized server 200 (step 1705), and the HTML rendering unit 129 of the browser 121 renders (visualizes) the search results (step 1706).

Subsequently, the browser 121 receives a recommended content of the search keyword from the content systematized server 200 (step 1707). The HTML rendering unit 129 of the browser 121 then displays the recommended content of the search keyword on a popped-up window (step 1708).

### (Processing at the Time of Performing Recommendation)

Next, a process flow 1800 of the content systematized server 200 at the time of performing a recommendation will be described. When giving an outline, the content systematized server 200 causes the proxy unit 228 to receive the search keyword from the client 100, and extract a search keyword related to the search keyword from the related link management information 530, and transmit the extracted search keyword to the client 100.

Concretely, as illustrated in FIG. 20B, the proxy unit 228 of the content systematized server 200 first receives the search keyword from the client 100 (step 1801). Next, the proxy unit 228 starts up the keyword recommendation generating unit 227, which determines whether to search the keyword table 540 for a URI of the search keyword (step 1802). If YES in step 1802, the keyword recommendation generating unit 227 searches the related link management information 530 for a record in which the related source is a URI of the search keyword and a class of the related destination is k (step 1803).

Next, the keyword recommendation generating unit 227 sorts the search results using a value of the counter 535 (refer to FIG. 6) of the related link management information 530 (step 1804).

Subsequently, the keyword recommendation generating unit 227 transfers the sorted search results to the proxy unit 228, which transmits the sorted search results to the browser 121 (step 1805). This enables the browser 121 to receive a recommendation of a search keyword related to the input search keyword.

### Concrete Example

Concrete examples according to the first embodiment will be described below with reference to FIGS. 21A and 21B. In this concrete example, it is understood as suitable that a method for obtaining a backup of a file system at high speed is surveyed as a survey content and as a result of the survey, a backup command is not used, and a method for setting a snapshot and structuring a RAID (Redundant Arrays of Inexpensive Disks) is adopted as an alternate solution. The related link between respective documents is learned from this survey results. By doing so, when another user performs a search using the “backup” as a search keyword during the survey of a similar item, the “snapshot” and the “RAID” of the search keyword that quickly reaches each manual page are assumed to be presented to the user. This concrete example will be described in detail below.

Concrete examples at the time of learning the related link will be first described with reference to FIG. 21A. FIG. 21A(a) is a conceptual diagram illustrating a relationship among a search keyword, a Web page, and a prepared document, and FIG. 21A(b) illustrates an example of a keyword table, a related event table, and a related link management information.

Here, suppose that a user that operates the client 100 surveys the speeding up of a backup of a file system. Much time is required for backing up the file system to affect the user's operations and the backup is desired to be completed at shorter times as a supposed condition.

The user first specifies the “backup (k1-a)” and the “speeding up (k1-b)” as the search keyword and performs a search. The user then refers to the “manual for a backup method (p1-a)” from the search results. It has become clear from this reference that it is impossible to shorten the time required for a backup by a device of a method for using a backup command.

Next, fragmentary information in which the speeding up of backup may be able to be carried out using a hot standby is obtained with reference to a “fragmentary comment in relation to a hot standby (p1-b)” from a list of search results using the “backup (k1-a)” and the “speeding up (k1-b)”. The user performs a search using the “hot standby (k2)” as the search keyword and refers to the “manual for setting the hot standby (p2)” to survey a detail of the hot standby. Here, the user obtains information that the hot standby is a method for improving availability and multiplexing a process. Since the backup is a method for improving durability and multiplexing data, the user determines that the hot standby cannot be used for an alternative solution of the backup.

Further, the user refers to a “fragmentary comment in relation to a snapshot (p1-c)” and obtains the following information from the previous list of search results using the “backup (k1-a)” and the “speeding up (k1-b)”. The snapshot is a technique that a virtual backup is obtained at some point and only a change part is stored from that point to thereby respond to a failure caused by an operation error of the user. Note, however, that it has become clear that during the application of the snapshot, redundancy is collectively required for the purpose of responding to media failures

Next, the user performs a search using the “snapshot (k3)” as the search keyword and refers to the “manual for setting the snapshot (p3)” to survey a detail in relation to the snapshot. Here, the user understands how to take the snapshot. The user performs a search using the “redundancy (k4)” as the search keyword and refers to a “supporting documentation for the redundancy (p4)” from the search results to survey the redundancy. It has become clear from this reference that adoption of the RAID configuration can respond to the redundancy in the survey. Therefore, the user advances a detailed survey of the RAID. Next, the user performs a search using the “RAID (k5)” as the search keyword and refers to the “manual for the RAID configuration (p5)” to understand a procedure.

As a result of the above survey, the user prepares a document (c1) summarized as described below. That is, the user prepares the document (c1) that “the backup cannot be speeded up by the device of the backup command (refer to the document of p1-a) and the same speeding up as that of the backup can be performed as an alternate solution by using the snapshot (refer to the document of p3) and the RAID (refer to the document of p5)”.

For the preparation of the document (c1), the user refers to and cites the “manual for the backup method (p1-a)”, the “manual for setting the snapshot (p3)”, and the “manual for the RAID configuration (p5)”. When searching the “manual for the backup method (p1-a)”, the “manual for setting the snapshot (p3)”, and the “manual for the RAID configuration (p5)”, the user performs a search using the “backup (k1-a)” and the “speeding up (k1-b)”, the “snapshot (k3), and the “RAID (k5)” as the search keyword, respectively.

These related events are stored in the related event table 510a. As illustrated in the related link management information 530a (not partially shown), the related link is generated between both arbitrary documents of the “document c1”, the “manual for the backup method (p1-a)”, the “manual for setting the snapshot (p3)”, the “manual for the RAID configuration (p5)”, the “backup (k1-a)”, the “speeding up (k1-b)”, the “snapshot (k3)”, and the “RAID (k5)”.

Next, concrete examples of operations at the time of performing the recommendation will be described with reference to FIG. 21B. Another user different from the user at the time of learning the related link performs a search using a term of the “backup” as the search keyword in the similar item survey. As illustrated in the keyword table 540a, the search keyword “backup” is denoted as k1-a in the related link learning. Further, as illustrated in the related link management information 530a, the “snapshot” denoted as k3 and the “RAID” denoted as k5 are used as the search keyword having the related link along with the search keyword “backup (k1-a)”. At the time of inputting the search keyword, since the related search keyword is assumed to be presented, the search keyword having a class k of the related destination is here disclosed.

Therefore, as can be seen from the related link management information 530a, when the search is performed based on the search keyword of the “backup”, the search keyword of the “snapshot” and the “RAID” can be presented to the user. When thus receiving the presentation of the search keyword having the related link, the user can reach the effective search keyword more quickly. The user quickly reaches the effective search keyword, and as a result, can reach the effective document more quickly. Thus, the user can reduce the number of times for inputting various search keywords by the trial-and-error method to browse documents. In short, the user takes advantage of a search history of forerunners, thereby using know how of forerunners.

In the case of this example, in a technique of using a statistical processing (refer to Patent Document 1) performed by paying attention to cooccurrence of conventional keywords, a possibility incapable of recommending the search keyword such as the “snapshot” and the “RAID” based on the search keyword such as the “backup” is considerably present. However, the above-described recommendation can be surely realized by a method according to the present embodiment.

### Second Embodiment

Next, a related document display system 1000a of a second embodiment will be described. The second embodiment differs from the first embodiment in a method for generating and storing the related link. In the first embodiment, after the item session-classified available document list is once prepared from the related event table 510, the related link is prepared using the item session-classified available document list. Meanwhile, in the second embodiment, the related link is prepared in a step of preparing the item session-classified available document list table 520a using the related event table 510. Further, in the first embodiment, the related link holds its information in a format of the related event table 510, and in the second embodiment, the related link generates and holds its information in a graph format of an object.

A portion different from the first embodiment will be first described on a structure of the software. FIG. 22 illustrates a structure of software and hardware according to the second embodiment. Portions different from the first embodiment are a relation generating unit 225a, a keyword recommendation generating unit 227a, a related link management information 530a, an item session-classified available document list table 520a, a search previously-visited document management table 640, and a related link generating stack 650 in a content systematize server 200a. The second embodiment has no available document list generating unit 224. Processing contents of the relation generating unit 225a and the keyword recommendation generating unit 227a will be described below.

The related link management information 530a will be first described. The related link management information 530a is constituted by a plurality of related link nodes 610 (refer to FIG. 23), a plurality of document nodes 620 (refer to FIG. 24), and a URI-document node correspondence management table 630 (refer to FIG. 25); further, these parts illustrate information of the related link.

FIG. 23 illustrates one example of the related link node 610. The related link node 610 has a combination of information units including a relevance ratio 611 and a pointer 612 to the document node 620. The relevance ratio 611 is an index value indicating how a relevance between documents related to each other by the related link is strong, and corresponds to the counter 535 (refer to FIG. 6) of the related link management information 530 according to the first embodiment.

FIG. 24 illustrates one example of the document node 620. The document node 620 has a combination of information units including a URI 621 indicating the document, a class 622 of the document, and a list of a pointer 623 for storing pointers to one or a plurality of the related link nodes 610. A list of the pointer 623 is implemented using an array and a linked list, and provided by a standard library in an execution environment of a programming language. A detailed description will be omitted in the present embodiment.

FIG. 25 illustrates one example of the URI-document node correspondence management table 630. The URI-document node correspondence management table 630 holds a combination of information units including a document URI 631 and a pointer 632 to the document node.

Next, FIG. 26 illustrates one example of a graph structure of the related link illustrated by the related link node 610 and the document node 620, and a part of the URI-document node correspondence management table 630.

In FIG. 26, each document node points the related link node 610. Meanwhile, each related link node 610 points the document node. In addition, in FIG. 26, a value shown in the related link node 610 indicates the relevance ratio 611. As described above, the second embodiment holds information on the related link illustrated in a graph structure.

FIG. 27 illustrates one example of the item session-classified available document list table 520a and the search previously-visited document management table 640. The item session-classified available document list table 520a holds information on a URI 522a. The search previously-visited document management table 640 holds information on a URI 641. The item session-classified available document list table 520a and the search previously-visited document management table 640 are used to manage whether a document is visited in the after-mentioned search.

The second embodiment uses the related link generating stack 650 for calculating the relevance ratio 611 of the related link node 610. FIG. 28 illustrates one example of the related link generating stack 650. The related link generating stack 650 stacks the document URI 651. Further, the related link generating stack 650 has an element number 652 indicating the number of elements of the related link generating stack 650. When an element is pushed into the related link generating stack, “1” is added to a value of the element number 652, and meanwhile, when an element is popped up from the related link generating stack, “1” is subtracted from a value of the element number 652. This related link generating stack 650 is not used to search a tree structure using the related events as in the available document circulating stack 580 according to the first embodiment.

Next, an operation image of the entire flow and a relationship between respective structures will be described with reference to FIGS. 29 and 30. Processing contents in steps 1001 to 1004 are the same as those of the first embodiment. In the first embodiment (refer to FIG. 12), the item session-classified available document list table 520 is generated from the related event table 510 (step 1005) to generate the related link (step 1006). Meanwhile, in the second embodiment, the related link is generated in a step of preparing the item session-classified available document list table 520a from the related event table 510 (step 1006a). When giving the above-described outline, the relation generating unit 225a refers to the related event table 510, and generates the related link using the item session-classified available document list table 520a, the search previously-visited document management table 640, and the related link generating stack 650. Then, the relation generating unit 225a stores the generated information on the related link in the related link management information 530a.

A processing in step 1006a of generating the related link will be described in detail. On the assumption that in a processing up to step 1004, each information on the related event is stored in the related event table 510 in the same manner as in the first embodiment, and the client 100 registers the prepared document in the content systematized server 200, a processing in step 1006 and subsequent steps will be described.

A processing (step 1006a) of generating the related link from information on the related event table 510 will be described in detail with reference to FIGS. 31A to 31D and FIG. 22. In a processing in FIGS. 31A to 31D, a search beginning at the prepared document is set up as a double loop based on the information stored in the related event table 510, thereby generating the related link between two arbitrary documents among the available documents.

In a process flow for generating the related link in FIG. 31A, the relation generating unit 225a first performs a first search using as an argument a URI of the prepared document (step 1901). The prepared document in this step 1901 is a prepared document received from the client 100 by the related learning controller 223 in step 1003 (refer to FIG. 29).

### (Processing of First Search)

Next, a processing content of the first search in step 1901 will be described in detail with reference to FIGS. 31B and 22.

The first search (step 1901) is called up using as an argument a URI of the prepared document. The relation generating unit 225a first pushes a URI of the prepared document specified by the argument into a first related link generating stack 650a (step 1903). In addition, suppose that the related link generating stack 650 includes a first related link generating stack 650a and a second related link generating stack 650b.

Next, the relation generating part 225a stores a URI as an argument of the first search in the item session-classified available document list table 520a (step 1904).

Next, the relation generating unit 225a clears a content of the search previously-visited document management table 640 (step 1905).

Then, the relation generating unit 225a calls up a second search using as an argument a URI of the argument at the time of calling up the first search (step 1906). This processing content of the second search will be described in detail below.

The relation generating unit 225a repeats a processing in steps 1907 to 1910 to a record having a document URI as an argument in the URI 512 (refer to FIG. 4) of the related source of the related event table 510. Note, however, that the relation generating unit 225a performs this repetition processing to a record having the same item session ID as that of the prepared document in the item session ID 511 of the related event table 510.

The relation generating unit 225a determines whether the URI 514 of the related destination in the record is present in the item session-classified available document list table 520a (refer to FIG. 27) (step 1908). If NO in step 1908, the relation generating unit 225a goes to step 1909. Meanwhile, if YES in step 1908, the relation generating unit 225a goes to step 1910.

In step 1909, the relation generating unit 225a recursively calls up the first search using as an argument a URI of the related destination.

After completion of the processing in steps 1907 to 1910, the relation generating unit 225a pops up an element from the first related link generating stack 650a in step 1911, and ends the process (step 1912).

### (Processing of Second Search)

Next, a processing content of the second search (step 1906 in FIG. 31B) will be described with reference to FIG. 31C.

The relation generating unit 225a first pushes into the second related link generating stack 650b a document URI specified by the argument at the time of calling up the second search (step 1921).

Next, the relation generating unit 225a stores a URI as an argument of the second search in the search previously-visited document management table 640 (step 1922).

Subsequently, the relation generating unit 225a determines whether one URI as the second search argument and another URI as the first search argument that calls up the second search are equal to each other (step 1923). Since there is no necessity for generating the related link to the same document, this processing in step 1923 is a processing for determining whether the same document is browsed during the first and second searches.

If NO in step 1923, the relation generating unit 225a goes to step 1924. In step 1924, the relation generating unit 225a calculates the relevance ratio 611 between documents. A processing in step 1924 will be described in detail below with reference to FIG. 31D.

Next, the relation generating unit 225a searches the URI-document node correspondence management table 630 to obtain a document node indicated by the URI as an argument at the time of calling up the second search (step 1925).

Next, the relation generating unit 225a determines whether a related link node from one URI as the first search argument at the time of calling up the second search to another URI as the second search argument is present (step 1926).

If NO in step 1926, the relation generating unit 225a goes to step 1927.

Meanwhile, if YES in step 1926, the relation generating unit 225a goes to step 1928.

In step 1927, the relation generating unit 225a newly generates the related link node 610, and stores in the generated related link node 610 a pointer to the document node having a document URI as the second search argument and a value of the relevance ratio 611 calculated in step 1924. Further, the relation generating unit 225a collectively adds one pointer to the generated related link node 610 to another pointer to the related link node 610 in the document node 620 having in the URI 621 a document URI as the first search argument calling up the second search.

On the other hand, in step 1928, the relation generating unit 225a adds a value of the calculated relevance ratio 611 to the existing related link node 610 for updating.

Next, the relation generating unit 225a repeats a processing in steps 1929 to 1932 to a record having a document URI as an argument in the URI 512 of the related source of the related event table 510. Note, however, that the relation generating unit 225a performs this repetition processing to a record having the same item session ID as that of the prepared document in the item session ID 511 of the related event table 510.

The relation generating unit 225a determines whether the URI 514 of the related destination in the record is present in the search previously-visited document management table 640 (step 1930). If NO in step 1930, the relation generating unit 225a goes to step 1931. Meanwhile, if YES in step 1930, the relation generating unit 225a goes to step 1932.

In step 1931, the relation generating unit 225a recursively calls up the second search using as an argument a URI of the related destination.

After completion of the processing in steps 1929 to 1932, the relation generating unit 225a pops up an element from the second related link generating stack 650b in step 1933, and ends the process.

### (Calculation Processing of Relevance Ratio)

Next, a calculation processing of the relevance ratio 611 in step 1924 will be described in detail with reference to FIGS. 31D and 22.

The relation generating unit 225a first calculates a distance between documents for calculation of the relevance ratio 611. The distance between documents means the number of hops that via how many related events a distance between two available documents can be followed. The relation generating unit 225a calculates the distance by comparing the first related link generating stack 650a and the second related link generating stack 650b.

The relation generating unit 225a first repeats a processing in step 1942 until the maximum number of elements in the first related link generating stack 650a in step 1941. When the number of times to repeatedly perform this step 1942 is “i”, the relation generating unit 225a determines whether i-th values from the respective bottoms of the first and second related link generating stacks 650a and 650b are equal to each other. Note, however, that this value of “i” begins from “0”. If YES in step 1942, the relation generating unit 225a goes to step 1944 through a repetition processing in steps 1941 to 1943.

Next, in step 1944, the relation generating unit 225a calculates a difference between a value of “i” and the element number 652a of the first related link generating stack 650a.

Subsequently, in step 1945, the relation generating unit 225a calculates a difference between a value of “i” and the element number 652b of the second related link generating stack 650b.

Next, in step 1946, the relation generating unit 225a sums up values calculated in steps 1944 and 1945. The sum value is a value of the distance.

Next, in step 1947, the relation generating unit 225a finds an inverse number of the distance value calculated in step 1946, and sets this value to a value of the relevance ratio 611. Note, however, that a value of the relevance ratio 611 is not limited to a method for calculating an inverse number as described above, and the relevance ratio 611 may be calculated and set by another method.

A concrete example on the generation of the related link according to the second embodiment will be described with reference to FIG. 26. As illustrated in FIG. 26, when the related link node 610 is newly generated from k1 to k2, a related link node 610a having a pointer to a document node illustrating k2 is generated. Then, a pointer to this generated related link node 610a is added to the document node of k1. Here, when a distance from k1 to k2 is assumed to be “5”, the generated related link node 610a has “0.2” of the inverse number of the distance as the relevance ratio 611.

On the other hand, also the concrete example of the case of adding a value of the calculated relevance ratio 611 to the existing related link node 610 for updating will be described similarly with reference to FIG. 26. Suppose that the related link node 610b from p1 to k1 is present and the relevance ratio 611 is “2.0” at one time. Newly, suppose that a distance from p1 to k1 is “1” and the relevance ratio 611 as the inverse number of a distance is “1”. At this time, the relevance ratio 611 of the related link node 610 indicating the related link from p1 to k1 is “3.0”. As illustrated in FIG. 26, the related link node 610b indicating the related link from p1 to k1 is updated. A processing of the related link learning is described in detail above.

Next, a processing at the time of performing a recommendation according to the second embodiment will be described in detail. In the same manner as in the processing at the time of performing the recommendation according to the first embodiment, suppose a stage in which when the browser 121 of the client 100 receives an input of the search keyword for search, the content systematized server 200 presents a user a search keyword related to the search keyword. Since operations of the browser 121 on the client 100 side are performed in the same manner as in the first embodiment, a description will be omitted. A processing content of the keyword recommendation generating unit 227a different from the first embodiment will be here described with reference to FIG. 32.

FIG. 32 is one example of a processing flow 1800a illustrating a processing content of the content systematized server 200 at the time of performing a recommendation according to the second embodiment. Processing contents in steps 1801 and 1802 in FIG. 32 are the same as those in steps 1801 and 1802 in FIG. 20B, respectively.

Next, the keyword recommendation generating unit 227a searches for the document node 620 having a URI of the search keyword obtained in step 1802 (step 2001). Next, the keyword recommendation generating unit 227a searches the pointer 623 to the related link node in the document node 620 obtained in step 2001 to obtain the related link node 610 (step 2002).

Next, the keyword recommendation generating unit 227a sorts the related links obtained in previous processings using a value of the relevance ratio (refer to FIG. 23) of each related link node 610 (step 2003). Next, the keyword recommendation generating unit 227a transfers the sorted search result to the proxy unit 228, and the proxy unit 228 transmits the sorted search result to the browser 121 (step 1805), and ends the process. This process enables the browser 121 to receive the recommendations of the search keyword related to the input search keyword.

As described above, the related document display system 1000 according to the present embodiment can surely recommend appropriate search keywords such as the “snapshot” and the “RAID” based on the search keyword such as the “backup” in the above-described example, for example, during the document search in the survey business using a set of documents as electronic data.

In short, unlike a conventional technology, and the related document display system 1000 can present the related keyword that a result set is a logical sum (OR). In this case, it is important that information that is not necessarily present in the present search result set and that has a close business relation can be efficiently presented.

Since past search history data is analyzed and used in each item session, a relevance between both information units can be generally presented also in a business in which the number of times of reference is small to a degree unfit for a statistical processing.

The description of the present embodiment is ended and aspects of the present invention are not limited thereto.

For example, in the present embodiment, the client 100, the content systematized server 200, the search server 301, and the Web server 302 are described as respective separate hardware structures; further, two or more arbitrary servers may be structured into one server in a hardware.

Further, a start of the item session may be recognized by an explicit instruction of a user, or automatically recognized when a user inputs the search keyword; both are applicable.

Further, even if a start of the item session is not recognized, the user always memorizes a search operation content and both arbitrary related events may be stored in the related event table 510 based on the operation content always memorized in relation to the corresponding item sessions when a predetermined document (c1) is prepared.

In the present embodiment, the case in which on the processing at the time of performing the recommendation, when the user inputs the search keyword, the related search keyword is presented is described; further, the present embodiment is applicable also to another stage, for example, a case in which when the user browses a document, a related document is presented.

When a program for causing each computer composing the related document display system 1000 to execute a processing is prepared to install the prepared program in the computer, each computer can realize each function based on the program.

In addition, on a specific structure of a hardware and program, changes may be arbitrarily made without departing from the spirit of the present invention. It should be further understood by those skilled in the art that although the foregoing description has been made on embodiments of the invention, the invention is not limited thereto and various changes and modification may be made without departing from the spirit of the invention and the scope of the appended claims.

1. A related document display system that displays a document related to a document browsed by a user from a set of documents as electronic data to the user, comprising:
a related learning controller that manages, when a new document is prepared by the user that uses the set of documents, a series of accesses by the user to the set of documents from a start to an end of a preparation of the new document as one item session,
captures an operation content during access to the set of documents by the user in each item session, and stores based on the operation content both related documents in the set of documents as a related event in a related event storage unit, and
refers to the related event storage unit, follows related documents in sequence based on the related event by beginning at the prepared document in the set of documents, and stores two arbitrary documents among followed documents as an available related link in the related link storage unit; and
a recommended controller that then refers, when the user browses any one of documents in the set of documents, to the related link storage unit, and extracts a document having an available related link along with the browsed document, and
displays the extracted document on a display unit as a document related to the browsed document.

2. The related document display system according to claim 1, wherein:
the related learning controller recognizes a start of the item session by an input of the effect that the user starts a document preparation.

3. The related document display system according to claim 1, wherein:
the related learning controller recognizes a start of the item session by an operation input for a document preparation by the user.

4. The related document display system according to claim 1, wherein:
the related learning controller always stores the operation content by the user, and stores, when the document is prepared, two arbitrary documents having a related event in the related event storage unit based on the always-stored operation content on the corresponding item session.

5. The related document display system according to claim 1, wherein:
the related learning controller recognizes as the related event the fact that the user follows a hyperlink of a web page as a document and transits a web page as another document, and stores the two documents as an available related link in the related event storage unit.

6. The related document display system according to claim 1, wherein:
the related learning controller recognizes as a related event the fact that at least a part of text data of the document is copied and pasted into the prepared document, and stores the copied document and the pasted document as an available related link in the related event storage unit.

7. The related document display system according to claim 1, wherein:
the related learning controller recognizes as a related event the fact that the user refers to a document obtained by a search using a search keyword, and stores the search keyword and the referred-to document as an available related link in the related event storage unit.

8. The related document display system according to claim 1, wherein:
the related learning controller collectively stores, when the two arbitrary documents are stored as an available related link in the related link storage unit, information having a larger relevance ratio as the number of search keywords and documents present to be followed between the two arbitrary documents is smaller for each related link in the related link storage unit; and
the recommended controller sorts and displays the extracted document according to the relevance ratio, when the extracted document is displayed on the display unit as a document related to the browsed document.

9. A related document display method executed by a related document display system that displays a document related to a document browsed by a user among a set of documents as electronic data to the user, the related document display system including a related event storage unit, a related link storage unit, a related learning controller, and a recommended controller, the method comprising causing:
the related learning controller to manage, when a new document is prepared by the user that uses the set of documents, a series of accesses by the user to the set of documents from a start to an end of a preparation of the new document as one item session,
capture an operation content during access to the set of documents by the user in each item session, store based on the operation content both related documents in the set of documents as a related event in a related event storage unit, and
refer to the related event storage unit, follow related documents in sequence based on the related event by beginning at the prepared document in the set of documents, and store two arbitrary documents among followed documents as an available related link in the related link storage unit; and
the recommended controller to then refer, when the user browses any one of documents in the set of documents, to the related link storage unit, extract a document having an available related link along with the browsed document, and
display the extracted document on a display unit as a document related to the browsed document.

10. The related document display method according to claim 9, wherein:
the related learning controller recognizes a start of the item session by an input of the effect that the user starts a document preparation.

11. The related document display method according to claim 9, wherein:
the related learning controller recognizes a start of the item session by an operation input for a document preparation by the user.

12. The related document display method according to claim 9, wherein:
the related learning controller always stores the operation content by the user, and stores, when the document is prepared, two arbitrary documents having a related event in the related event storage unit based on the always-stored operation content on the corresponding item session.

13. The related document display method according to claim 9, wherein:
the related learning controller recognizes as the related event the fact that the user follows a hyperlink of a web page as a document and transits a web page as another document, and stores the two documents as an available related link in the related event storage unit.

14. The related document display method according to claim 9, wherein:
the related learning controller recognizes as a related event the fact that at least a part of text data of the document is copied and pasted into the prepared document, and stores the copied document and the pasted document as an available related link in the related event storage unit.

15. The related document display method according to claim 9, wherein:
the related learning controller recognizes as a related event the fact that the user refers to a document obtained by a search using a search keyword, and stores the search keyword and the referred-to document as an available related link in the related event storage unit.

16. The related document display method according to claim 9, wherein:
the related learning controller collectively stores, when the two arbitrary documents are stored as an available related link in the related link storage unit, information having a larger relevance ratio as the number of search keywords and documents present to be followed between the two arbitrary documents is smaller for each related link in the related link storage unit; and
the recommended controller sorts and displays the extracted document according to the relevance ratio, when the extracted document is displayed on the display unit as a document related to the browsed document.

17. A program for causing a computer to function as the related document display system according to claim 1.
